(19) United States
(12) Patent Application Publication
(10) Pub. No.: US 2023/0335771 A1
(43) Pub. Date: Oct. 19, 2023

(54) BATTERIES WITH AQUEOUS ELECTROLYTES REINFORCED BY MG AND CA IONS

(71) Applicant: University of Utah Research Foundation, Salt Lake City, UT (US)

(72) Inventors: Tao Gao, Salt Lake City, UT (US); Jing Liu, Salt Lake City, UT (US)

(21) Appl. No.: 18/155,573

(22) Filed: Jan. 17, 2023

Related U.S. Application Data
(60) Provisional application No. 63/332,130, filed on Apr. 18, 2022.

(51) Int. Cl. H01M 8/18

(52) U.S. Cl. CPC H01M 8/188; H01M 2300/0005

(57) ABSTRACT

An iron redox battery can include an aqueous electrolyte that includes a dissolved iron salt and a dissolved co-salt. The co-salt can include an anion and a cation, where the anion is one or more of a multiatomic anion, bromide and iodide, and where the cation is a magnesium ion, a calcium ion, or a combination thereof. The battery can also include an iron-reducing electrode in contact with the aqueous electrolyte. The battery can be operated with a coulombic efficiency from about 95% to about 99.9%.

### CROSS REFERENCE TO RELATED APPLICATIONS

This application claims priority to U.S. Provisional Pat. Application No. 63/332,130 filed Apr. 18, 2022 which is incorporated herein by reference.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION BY REFERENCE STATEMENT

Not applicable.

### BACKGROUND

Iron (Fe) metal batteries, such as Fe-ion batteries and all Fe flow batteries, are promising energy storage technologies for grid applications due to the extremely low cost of Fe and Fe salts. Nonetheless, the cycle life of Fe metal batteries is poor primarily due to the low coulombic efficiency of the Fe deposition/stripping reaction. Current aqueous electrolytes based on Fe chloride or sulfate salts can only operate at a coulombic efficiency of < 91% under mild operation condition (< 5 mA/cm²), largely due to undesired hydrogen evolution reaction (HER).

Renewable energies, such as solar and wind, can decarbonize energy generation and help to address the climate change grand challenge. However, their intermittent nature makes their integration into the grid difficult. Battery energy storage is a scalable technology that can buffer the mismatch between renewable electricity generation and grid electricity demand, but the high cost remains the main obstacle for its wide deployment.

### SUMMARY

The present disclosure describes iron redox batteries with aqueous electrolytes reinforced by Mg and Ca ions that can operate with high efficiency and long battery life. In one example, an iron redox battery can include an aqueous electrolyte that includes a dissolved iron salt and a dissolved co-salt. The co-salt can include an anion and a cation. The anion can be one or more of a multiatomic anion, bromide, and iodide. The cation can be a magnesium ion, a calcium ion, or a combination thereof. The battery can also include an iron-reducing electrode in contact with the aqueous electrolyte.

In another example, an aqueous redox flow battery can include an aqueous electrolyte that includes a dissolved salt of an active metal. The active metal can include chromium, titanium, manganese, nickel, zinc, tin, copper, or a combination thereof. The aqueous electrolyte can also include a dissolve co-salt that includes an anion and a cation. The anion can be one or more of a multiatomic anion, bromide and iodide. The cation can be a magnesium ion, a calcium ion, or a combination thereof. The battery can also include an electrode in contact with the aqueous electrolyte.

The present disclosure also describes methods of operating an iron redox battery. In one example, a method can include depositing iron metal from an aqueous electrolyte within a battery onto an iron-reducing electrode while electric current flow through the battery in a first direction. The aqueous electrolyte can include dissolved iron salt and a dissolved co-salt. The co-salt can include an anion and a cation, wherein the anion is one or more of a multiatomic anion, bromide and iodide, while the cation is a magnesium ion, a calcium ion, or a combination thereof. The method can also include stripping the iron metal from the iron-reducing electrode while electric current flows through the battery in a second direction. The stripped iron metal can be converted into iron ions dissolved in the aqueous electrolyte.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIGS. 1A and 1B are schematic illustrations of the anode and electrolyte of an example iron redox battery, in accordance with the present disclosure.

FIG. 2 is a schematic illustration of another example iron redox battery, in accordance with the present disclosure.

FIG. 3 is a schematic illustration of yet another example redox battery with the aqueous electrolytes reinforced by Mg and Ca ions, in accordance with the present disclosure.

FIG. 4 is a flowchart of an example method of operating an iron redox battery, in accordance with the present disclosure.

FIG. 5 is a graph of X-ray diffraction patterns of Fe metal deposited on a Cu substrate.

FIG. 6 is a graph of energy dispersive spectroscopy of a Cu substrate after stripping of Fe metal.

FIG. 7 is a graph of potential curves of Fe electrolyte (FE) and FERMI-4.5 electrolyte.

FIG. 8 shows graphs of oxidation potentials of Cu vs. Fe/Fe²⁺ in FE, FERMI-4.5, and FERCI-4.5.

FIG. 9 shows the conductivity of 0.5 M FeCl₂ with different concentrations of MgCl₂ and CaCl₂.

FIG. 10 is a graph of Voltage vs. cycling time (50 cycles) of CulFe beaker cells with FE, FERMI-4.5 and FERCI-4.5.

FIG. 11 shows coulombic efficiency (CE) vs. cycle number for cycling CulFe beaker cells with FE and FERMI-4.5.

FIG. 12 shows average CE vs. Mg concentration of FERMI-x.

FIG. 13 shows linear scan voltammetry of FE, 4.5 M MgCl₂ and FERMI-x electrolytes in a CulFelFe three-electrode cell.

FIG. 14 shows linear scan voltammetry of FE, FERMI-4.5, and FERCI-4.5.

FIG. 15 is a graph of pH of 0.5 M FeCl₂ with different concentrations of MgCl₂ and CaCl₂.

FIG. 16 shows average CE of FE and FERMI-3.0 with Cl⁻ and SO₄²⁻.

FIG. 17 shows average CE of A (FE), B (FE+2.5 M FeCl₂ (3.0 M FeCl₂)), C (FE+5.0 M NaCl), D (FE+2.5 M MgCl₂) and E (FE+2.5 M CaCl₂) at different pHs.

FIG. 18 shows deposition/stripping voltage curves for FE and FERCI-4 in CulFe two-electrode cells.

FIG. 19 shows CE vs. cycle number for Fe and FERCI-4.5.

FIG. 20 shows average CE of Fe electrolytes at different CaCl₂ concentrations.

FIG. 21 shows linear scan voltammetry of FE, 4.5 M CaCl₂ and FERCI-x electrolyte in CulFelFe three-electrode cell.

FIG. 22 shows voltage profiles during the cycling of a CulFe beaker cell with FE, FERMI-4.5, and FERCI-4.5.

FIG. 23 shows cycling performance of Fe|Fe symmetric cells in FE, FERMI-4.5 and FERCI-4.5.

FIG. 24 shows a zoom-in view of the first and last four hours of the cycling results in FIG. 23.

FIG. 25 shows EIS results of as-made and failed Fe|Fe coin cells with 0.5 M FeCl₂.

FIG. 26 shows voltage profiles during cycling of LiFePO₄|Fe full cells with FE, FERMI-4.5, and FERCI-4.5.

FIG. 27 shows normalized capacity of LiFePO₄|Fe full cells with FE, FERMI-4.5, and FERCI-4.5.

FIG. 28 shows CE of LiFePO₄|Fe full cells with FE, FERMI-4.5, and FERCI-4.5.

FIG. 29 shows normalized capacity during cycling of LiFePO₄|Fe full cells in FE, FERMI-4.5 and FERCI-4.5 with no Li salts.

FIG. 30 shows CE during cycling of LiFePO₄|Fe full cells in FE, FERMI-4.5 and FERCI-4.5 with no Li salts.

FIG. 31 is a graph of intensity for Mg²⁺ electrolytes.

FIG. 32 is a graph of absorbance for Mg²⁺ electrolytes.

FIG. 33 is a graph of intensity for Ca²⁺ electrolytes.

FIG. 34 is a graph of absorbance for Ca²⁺ electrolytes.

FIG. 35 is a graph of capacity vs. cycle for a 0.5 M FeCl₂ electrolyte battery.

FIG. 36 is a graph of voltage vs. delivered capacity for the battery of FIG. 35.

FIG. 37 is a graph of capacity vs. cycle for a 0.5 M FeCl₂ plus 4.5 M CaCl₂ electrolyte battery.

FIG. 38 is a graph of voltage vs. delivered capacity for the battery of FIG. 37.

FIG. 39 is a graph of capacity vs. cycle for a 0.5 M FeCl₂ plus 4.5 M CaBr₂ electrolyte battery.

FIG. 40 is a graph of voltage vs. delivered capacity for the battery of FIG. 39.

FIG. 41 shows cation-oxygen of water radial distribution functions with corresponding coordination numbers for 0.5 M Fe Cl₂ + 4.5 M Mg Cl₂.

FIG. 42 shows cation-anion radial distribution functions with corresponding coordination numbers for 0.5 M Fe Cl₂ + 4.5 M Mg Cl₂.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### Definitions

In describing and claiming the present invention, the following terminology will be used.

The singular forms “a,” “an,” and “the” include plural referents unless the context clearly dictates otherwise. Thus, for example, reference to “an ion” includes reference to one or more of such materials and reference to “the electrode” refers to one or more of such electrodes.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility and imprecision associated with a given term, metric or value. The degree of flexibility for a particular variable can be readily determined by one skilled in the art. However, unless otherwise enunciated, the term “about” generally connotes flexibility of less than 2%, and most often less than 1%, and in some cases less than 0.01%.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

As used herein, the term “at least one of” is intended to be synonymous with “one or more of.” For example, “at least one of A, B and C” explicitly includes only A, only B, only C, or combinations of each.

Numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

### Aqueous Electrolytes

Among various battery technologies, aqueous iron (Fe) metal batteries are promising due to their low-cost potential. Fe is the second most abundant metal in the earth’s crust and is the most-produced metal commodity. In addition, Fe metal has a very high capacity (960 mAh/g and 7558 mAh/cm³), which outperforms zinc metal (820 mAh/g and 5854 mAh/cm³), the most popular metal anode used in aqueous batteries. Despite these efforts, the promise of aqueous Fe metal batteries has not been realized due to their limited cycle life. Fe deposition/stripping is the designed reaction that occurs at the anode in an aqueous Fe metal battery. However, the reversibility of this reaction is far from satisfactory to make a battery with a long lifespan. In acidic aqueous electrolytes, hydrogen evolution reaction (HER) can be thermodynamically more favorable than Fe deposition (HER: -0.12 V vs. standard hydrogen electrode (SHE) at pH=2; Fe deposition: -0.44 V vs. SHE). Consequently, HER competes with Fe deposition during the charging of a Fe battery. Unlike zinc metal which has a high overpotential for HER, Fe is known as a catalyst for HER, therefore HER kinetics are very facile on the deposited Fe. As a result, the coulombic efficiency (CE) of Fe deposition/stripping is less than 91 % in sulfate solutions and less than 87% in chloride solutions under mild deposition currents (< 5 mA/cm²). Such low CE leads to gas generation and electrolyte pH increase during battery cycling, which further causes the hydrolysis of Fe^{2+/3+}, precipitation of ferrous/ferric hydroxide, and battery performance degradation. Previous studies have shown that increasing electrolyte pH, adding ascorbic acid buffer, chloride, or Cd additive, and raising electrolyte temperature can increase CE. However, the best CE reported so far is still not sufficient to build a long cycle life Fe battery.

The present disclosure describes aqueous electrolytes that can deposit and strip Fe metal at high efficiency, such as 99.1 % efficiency or higher. This is a higher efficiency than previously achieved with other electrolytes in Fe metal batteries. The electrolytes, called Fe electrolyte reinforced with magnesium ions (FERMI) and Fe electrolyte reinforced with calcium ions (FERCI), can be made by adding magnesium ions or calcium ions to a FeCl₂ electrolyte. In certain examples, the magnesium ions or calcium ions can be provided by adding MgCl₂ or CaCl₂ salts into the FeCl₂ electrolyte. However, in other examples the magnesium ions or calcium ions can be introduced as a magnesium or calcium salt with an anion. The anion can be a multiatomic anion, bromide, iodide, or combinations of these options. Multiatomic anions, for example, SO₄²⁻, TFSI⁻, ClO₄⁻, can enable higher magnesium/calcium ion solubility, higher resistance to oxidation, or less corrosive electrolyte.

Accordingly, the present disclosure describes iron metal batteries that can include an aqueous electrolyte with dissolved iron ions and a dissolved co-salt. The co-salt can include an anion and a cation. The cation can be magnesium, calcium, or a combination thereof. The batteries can also include an iron deposition electrode in contact with the electrolyte. When the battery operates, iron metal can be deposited from the electrolyte onto the electrode and then stripped off the electrode repeatedly in charge/discharge cycles. The batteries can have high coulombic efficiency, and therefore the batteries can be used for many cycles without losing a large amount of iron in the process. As used herein, “deposit” refers to the formation of iron metal on the electrode. The iron metal atoms have an oxidation number of zero. These atoms are converted from Fe²⁺ ions dissolved in the electrolyte through a redox reaction, in which the ions are reduced to form metallic iron atoms. As used herein, “strip,” “stripping,” and “stripped” refer to the reverse of this process, in which iron metal atoms that have been deposited on the electrode are oxidized and converted to Fe²⁺ ions that go back into solution in the electrolyte. Some previous iron metal batteries have had low coulombic efficiency because some of the deposited iron metal becomes electrically insulated from the electrode. This “dead iron” is not converted back to Fe²⁺ because there is no pathway for electrons to flow from the dead iron to the electrode. This can reduce the capacity and performance of the battery.

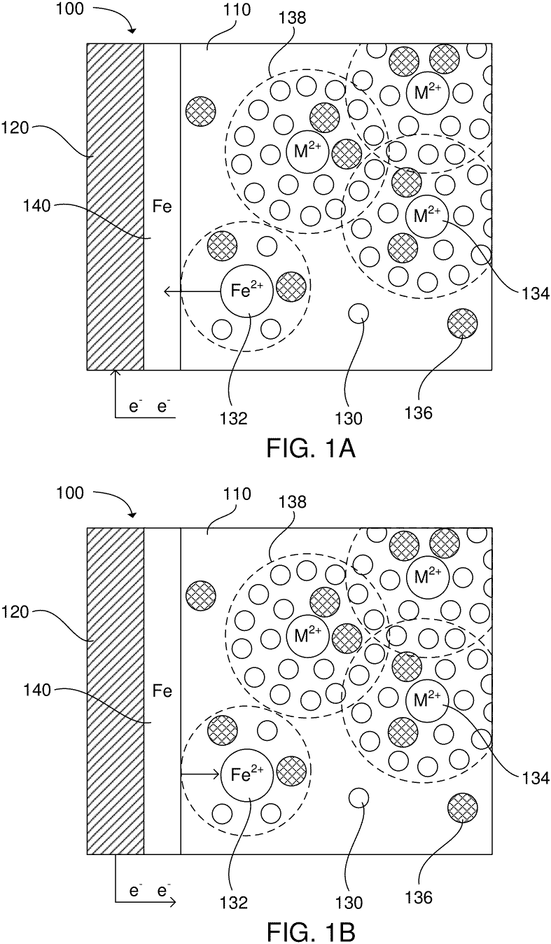

FIG. 1A is a schematic view an example iron redox battery 100. This battery includes an aqueous electrolyte 110 and an iron-reducing electrode 120 in contact with the aqueous electrolyte. The aqueous electrolyte includes water molecules 130, dissolved iron ions 132, dissolved cations 134 that can be magnesium or calcium, and dissolved anions 136. The cations and anions can be introduced into the aqueous electrolyte by dissolving a salt made up of the cation and the anion. Similarly, the iron ions can be introduced by dissolving an iron salt. In some examples, the iron salt can have a different anion, and the anion from the iron salt can also be present in the aqueous electrolyte. FIG. 1A also shows deposited iron metal 140 on the surface of the iron-reducing electrode. In this example, electrons are shown flowing into the iron-reducing electrode. Dissolved iron ions having a charge of 2+ can be reduced at the surface of the electrode, converting the iron ions into iron metal that is deposited on the surface. It is noted that the surface of the electrode may be coated by deposited iron metal after this process has proceeded sufficiently. The deposited iron metal can be considered a part of the electrode, and therefore the electrode can still be described as “in contact” with the aqueous electrolyte even when a coating of iron metal has been deposited on the whole surface of the electrode.

FIG. 1A also shows solvation shells 138 around the iron ions 132 and cations 134. Because of their charge, these ions form solvation shells, also known as hydration shells or coordination shells, in which a number of nearby water molecules 130 are immobilized in a shell around the ions. Magnesium and calcium ions have been found to hold more water molecules in their solvation shells than iron ions. In some examples, iron ions can hold about 6 water molecules in their solvation shells, while magnesium and calcium ions can hold about 20 water molecules in their solvation shells. Thus, when magnesium or calcium ions are added to the electrolyte, more of the water molecules in the electrolyte become immobilized in the solvation shells around the magnesium or calcium ions. The fraction of water molecules that are in solvation shells increases with increasing cation concentration until at a certain cation concentration, nearly all water molecules in the electrolyte will be part of a solvation shell. In some examples, the magnesium or calcium cations can pull some of the water molecules away from the solvation shells of iron ions. Thus, the iron ions may have fewer water molecules in their solvation shells when the magnesium or calcium cations are added.

FIG. 1B shows the same example battery 100 while electric current flows in the opposite direction. In this figure, electrons flow away from the electrode, and the iron metal that had been deposited on the electrode is converted back to Fe²⁺ ions, which are stripped from the electrode and which dissolve back into the electrolyte. The deposition and stripping of iron metal can have greater reversibility in the batteries described herein compared to previous iron metal batteries. The batteries described herein have been found to deposit iron metal evenly and to strip the iron away in a highly reversible process so that the battery can be charged and discharged many times. The batteries have also been found to produce minimal hydrogen gas through the hydrogen evolution reaction, which is an undesired side reaction that often occurs in iron metal batteries.

The mechanisms that cause the increase performance of the batteries described herein are not fully understood. However, one likely mechanism is related to the solvation shells of the magnesium or calcium cations. As explained above, these cations can immobilize a large number of water molecules in their solvation shells. Water molecules that are not in a solvation shell can freely move and rotate in the bulk water of the electrolyte. These free water molecules tend to form hydrogen bonds with nearby water molecules. The hydrogen bonds pull the hydrogen atoms away from the oxygen atoms to which they are covalently bonded somewhat, which lengthens and weakens the covalent bond between the oxygen atoms and the hydrogen atoms. In contrast, water molecules that are within a solvation shell are geometrically constrained and are not able to form as many hydrogen bonds with neighboring water molecules. Therefore, the covalent bonds between the oxygen atoms and hydrogen atoms in these water molecules is shorter and stronger than the free water molecules. When most of the water molecules are immobilized within the solvation shells of the cations, it is more difficult for the covalent bonds between the oxygen atoms and hydrogen atoms to be broken, and this makes the hydrogen evolution reaction less favorable. The solvation shells of the magnesium and calcium cations can also pull water molecules out of the solvation shells of the iron ions. Therefore, there are few water molecules near the iron ions when the iron ions are deposited onto the electrode surface. Both of these effects can reduce the occurrence of the hydrogen evolution reaction. In some examples, the concentration of magnesium or calcium cations in the electrolyte can be sufficient to eliminate or substantially eliminate the hydrogen evolution reaction.

In more detail regarding the aqueous electrolyte of the batteries described herein, the aqueous electrolyte can include a dissolved iron salt. The iron salt can be water soluble. In some examples, the iron salt can be soluble in water in an amount from about 0.1 molar (M) to about 3.0 M. In further examples, the iron salt can be soluble in amount from about 0.3 M to about 3.0 M, or from about 0.5 M to about 3.0 M, or from about 1.0 M to about 3.0 M, or from about 1.0 M to about 2.0 M, or from about 0.5 M to about 2.0 M. In further examples, these solubility ranges can be with respect to an aqueous electrolyte having a pH from 1.0 to 3.0.

The electrolyte can include the dissolved iron salt in any desired amount up to the solubility limit of the iron salt. In some examples, the concentration of iron salt in the electrolyte can be from about 0.1 M to about 3.0 M. In further examples, the concentration can be from about 0.1 M to about 2.0 M, or from about 0.1 M to about 1.0 M, or from about 0.1 M to about 0.5 M, or from about 0.3 M to about 0.7 M, or from about 0.5 M to about 1.0 M, or from about 0.5 M to about 2.0 M, or from about 0.5 M to about 3.0 M. These are concentrations of the iron ions. If the iron salt includes multiple anions per iron atom or multiple iron atoms per anion, then the concentration of the anion in the electrolyte may be different.

The iron salt can be a ferrous salt, or in other words, a salt of iron(II). Non-limiting examples of iron salts can include iron(II) chloride (FeCl₂), iron(II) sulfate (FeSO₄), iron(II) bis(trifluoromethanesulfonyl)imide (FeTFSI₂), iron(II) trifluoromethanesulfonate (Fe(CF₃SO₃)₂), and combinations thereof. These salts can dissolve in the aqueous electrolyte to provide Fe²⁺ ions and dissolved anions that originate from the iron salt. In a particular example, the electrolyte can include FeCl₂ at a concentration of about 0.5 M.

The aqueous electrolyte can also include a dissolved co-salt, in addition to the iron salt. The co-salt can include a cation that is magnesium, calcium, or a combination thereof. In certain examples, the co-salt can include magnesium as the cation, without calcium. In other examples, the co-salt can include calcium as the cation, without magnesium.

The co-salt can also include a multiatomic anion. The multiatomic anion can be an anion made up of multiple atoms bonded together in a single anion. For example, a sulfate anion (SO₄²⁻) is a multiatomic anion made up of one sulfur atom and four oxygen atoms. In contrast, chloride (Cl⁻) is a single atom ion. In various examples, the co-salt can include a multiatomic anion such as sulfate, perchlorate, nitrate, bis(trifluoromethanesulfonimide), trifluoromethanesulfonate, or a combination thereof.

In further examples, the multiatomic anion can include a multi-dentate anion. For example, multi-dentate anion can be used such as, but not limited to, oxalate(C₂O₄²⁻), sulfate (SO₄²⁻), mesylate (CH₃SO₃⁻), and the like.

In other examples, the anion can be a bromide or iodide. Non-limiting examples of co-salts with these anions can include bromide and iodide salts of alkali and alkaline-earth metals, hydrogen, silver, and the like.

The amount of co-salt added to the electrolyte can have a strong impact on the performance of the battery, as explained above. In some examples, the amount of co-salt added to the electrolyte can be sufficient so that the cation (Mg²⁺ or Ca²⁺) is present in the electrolyte at a concentration from about 0.5 M to about 5.0 M, or from about 1.0 M to about 5.0 M, or from about 1.5 M to about 5.0 M, or from about 2.0 M to about 5.0 M, or from about 3.0 M to about 5.0 M, or from about 4.0 M to about 5.0 M. In certain examples, the cation can be present at a concentration greater than 1.0 M, such as from greater than 1.0 M to about 5.0 M.

Adding a large amount of co-salt to the electrolyte can also make the electrolyte more viscous in some cases. However, it can be useful to have a sufficiently low viscosity so that the electrolyte can be circulated by a pump in a flow battery. In some examples, the aqueous electrolyte can have a viscosity of less than about 6.4 cP.

For flow batteries, a high concentration of active ion and co-ions are sometimes necessary to achieve optimal performance. In this regard, viscosity of up to 6.4 cP can be acceptable. To reduce the viscosity of the electrolyte, low-viscosity non-solvent can be added, for example, organic solvents such as dimethyl carbonate. Further, the pump power requirement of high viscosity electrolyte can be mitigated by reducing flow rate, enlarging the cross-sectional area of tubing, and/or shortening the distance of tubing.

The pH of the aqueous electrolyte can also affect the deposition and stripping of iron metal on the electrode. In some examples, the pH of the electrolyte can be from about 1 to about 3. In further examples, the pH can be from about 1.2 to about 3.0, or from about 1.3 to about 3.0, or from about 1.3 to about 2.7, or from about 1.5 to about 2.5, or from about 1.8 to about 2.5, or from about 1.8 to about 2.3, or from about 1.9 to about 2.1.

The particular combination of iron active metal and the aqueous electrolyte described herein can allow the batteries described herein to operate with greatly reduced or eliminated hydrogen evolution reaction (HER). Many previous iron metal batteries have produced a significant amount of hydrogen gas through HER. The hydrogen gas can be produced when the hydrogen atoms of water molecules are reduced instead of the iron ions being reduced at the electrode. Hydrogen evolution can mechanically damage batteries due to pressure build up. Hydrogen is also highly flammable, and therefore batteries that produce hydrogen gas are a fire hazard. As explained above, the co-salts in the aqueous electrode can help to reduce or eliminate HER when the battery is in operation. In some examples, the battery can operate substantially without evolving hydrogen gas from the aqueous electrolyte. In further examples, the amount of hydrogen evolved from the aqueous electrolyte can be very small compared to the amount of iron ions that are being deposited and stripped during the charging and discharging cycles of the battery. In certain examples, the amount of hydrogen produced by the battery can be less than 0.5 mole of hydrogen gas for every 10 moles of iron ions that are deposited on the electrode, and in some cases less than 0.1 mole of hydrogen gas for every 10 moles of iron ions, and in other cases less than 0.01 mole of hydrogen gas for every 10 moles of iron ions deposited.

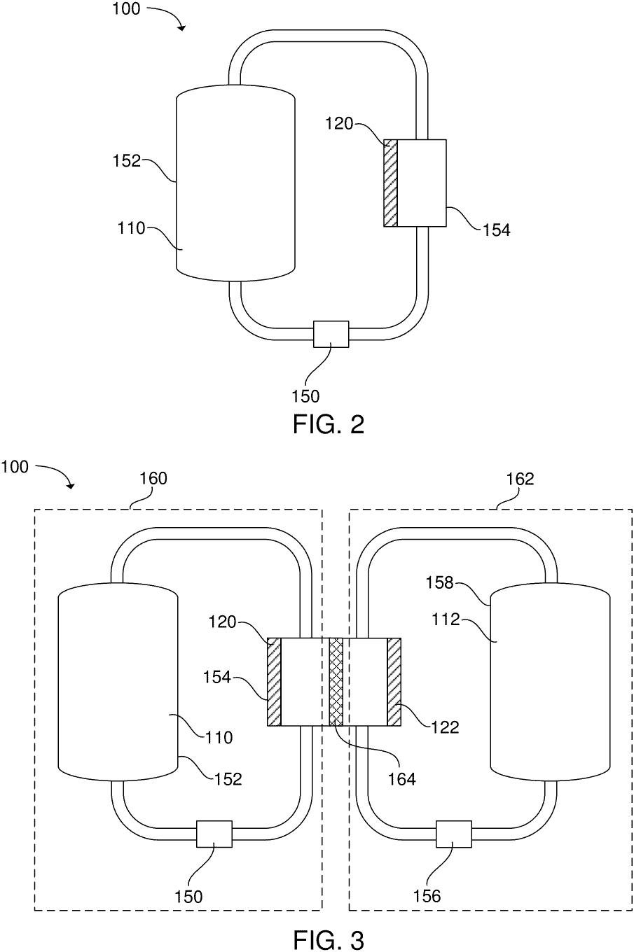

The batteries described herein can be redox flow batteries in some examples. In such examples, the battery can include a pump that is configured to pump the aqueous electrolyte to the iron-reducing electrode. FIG. 2 is a schematic illustration of an example redox flow battery 100 that includes a pump 150. The pump is connected to an electrolyte tank 152 and a flow cell 154. The flow cell includes the electrode 120. In this example, the pump circulates the aqueous electrolyte 110 from the electrolyte tank, through the flow cell, and back to the electrolyte tank. When iron ions from the electrolyte are being deposited onto the electrode, the circulation of the electrolyte can ensure that the concentration of iron ions does not drop too quickly as the iron ions are depleted from the electrolyte near the electrode. Similarly, when the iron metal is being stripped from the electrode, circulating the electrolyte can provide fresh electrolyte flowing past the electrode so that the concentration of iron ions near the electrode does not become too high.

In further examples, the redox flow battery can include two half-cells. A first half-cell can include the electrode and the aqueous electrolyte described above. A second half-cell can include a second electrode and a second electrolyte in some examples. FIG. 3 is a schematic illustration of such a battery 100. This example includes a first half-cell 160 that includes a first electrolyte 110 and a first electrode 120. This example also includes a first pump 150 and a first electrolyte tank 152. The battery also includes a second half-cell 162 with a second electrolyte 112 and a second electrode 122. The second half-cell also includes a second pump 156 and a second electrolyte tank 158. In this example, both the first electrolyte and the second electrolyte are circulated to a flow cell 154. The flow includes a membrane 164 separating the first electrolyte from the second electrolyte. In some examples, ions can pass through the membrane. The membrane can be an ion-selective membrane that allows certain ions to pass through while blocking other ions. In one example, the membrane can selectively allow Fe²⁺ to pass through the membrane. In a particular example, Fe²⁺ ions can be oxidized at the second electrode and reduced at the first electrode.

The electrode materials can include a variety of electrically conductive materials. In some examples, the iron-reducing electrode can include copper metal, iron metal, LiFePO₄, graphite, carbon felt, carbon cloth, carbon paper, titanium, or a combination thereof. In examples that include a second electrode or a third electrode, the second or third electrodes can also be made of any of these materials. Some specific types of batteries that can be made according the present technology can include LiFePO₄|Fe full cell batteries, CulFe two-electrode cell batteries, CulFelFe three-electrode cell batteries, Fe|Fe symmetrical cell batteries, Fe³⁺|Fe cell, a Cl²|Fe cell, a Br₂/Fe cell, a I/Fe cell, a O₂/Fe cell, or a Fe(CN)₆³⁻/Fe cell.

In further examples, it may be useful to add a co-salt to electrolytes for batteries that utilize a different active metal besides iron. The co-salts described above, which include a magnesium or calcium cation and a multiatomic anion, can be added to a variety of electrolytes in other types of batteries. In certain examples, such electrolytes can include a dissolved salt of an active metal, where the active metal can include chromium, titanium, manganese, nickel, zinc, tin, copper, or a combination thereof.

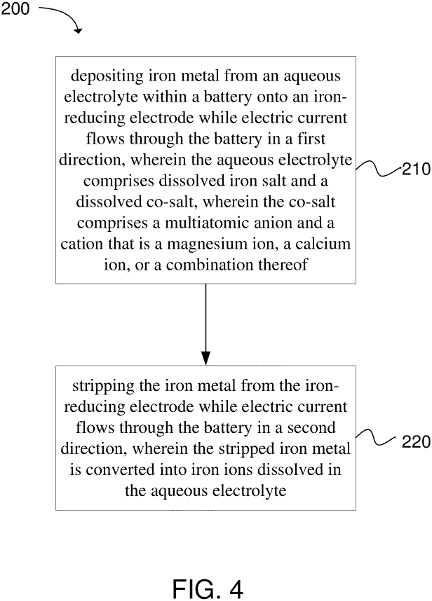

The present disclosure also describes methods of operating iron redox batteries. FIG. 4 shows a flowchart of one example method 200 of operating an iron redox battery. This method includes: depositing iron metal from an aqueous electrolyte within a battery onto an iron-reducing electrode while electric current flows through the battery in a first direction, wherein the aqueous electrolyte comprises dissolved iron salt and a dissolved co-salt, wherein the co-salt comprises a multiatomic anion and a cation that is a magnesium ion, a calcium ion, or a combination thereof 210; and stripping the iron metal from the iron-reducing electrode while electric current flows through the battery in a second direction, wherein the stripped iron metal is converted into iron ions dissolved in the aqueous electrolyte 220.

The deposition and stripping processes can occur during a charging phase or discharging phase, depending on the design of the particular battery. The iron ions can be deposited onto the iron-reducing electrode when electrons flow into the iron-reducing electrode. These electrons can reduce the Fe²⁺ ions to Fe metal atoms. The stripping process can occur when electrons flow out of the iron-reducing electrode. In this process, Fe metal atoms are oxidized to Fe²⁺ ions and the electrons taken from the Fe metal atoms flow out of the electrode.

As mentioned above, the battery can have high coulombic efficiency. In certain examples, the battery can operate with a coulombic efficiency from about 95% to about 99.9%, or from about 95% to about 99.3%, or from about 95% to about 99.1%, or from about 97% to about 99.9%, or from about 97% to about 99.3%, or from about 99% to about 99.3%, or from about 99% to about 99.9%.

The methods can also include making the batteries with any of the features and components described above, and operating the batteries in any of the ways described above.

### Example 1: Physical Experiments

Pure Fe electrolyte is made by dissolving the Fe salt into deionized water. An example aqueous iron electrolyte reinforced with magnesium ions (FERMI) was made by dissolving MgCl₂ into the Fe electrolyte. The Fe electrolyte had a concentration of 0.5 M FeCl₂ (FE). This concentration was selected as a baseline for comparing the Fe deposition/stripping efficiency and other performance of Fe electrolytes. Baseline Fe electrolytes with different concentrations of Magnesium (Mg) ions/Calcium (Ca) ions are denoted in this example as FERMI-x/FERCI-x, in which x is the molarity of the Mg/Ca ion.

The pure Fe-electrolyte is made by dissolving FeCl₂ into DI-water. To make the electrolyte, the deionized water was purged with N₂ for two hours to thoroughly eliminate the dissolved O₂. The FERMI and FERCI are prepared by dissolving MgCl₂ or CaCl₂ salt into the pure Fe-electrolyte and then mixed with a vortex mixer for ten minutes. For all the electrochemical tests, fresh electrolytes are made and used immediately to avoid the oxidation of Fe²⁺. All the electrochemical tests are done in air-tight devices (coin cells or sealed glass cells). The molarity of the solution is controlled by mixing the salts with a predetermined amount of DI water and then gradually adding more DI water until the solution reaches the target volume. The pH of the electrolyte is measured with the Mettler-Toledo FiveEasy pH meter, and the pH probe is calibrated with pH7 and pH1 buffer before the measurement. 4% HCl solution was added dropwise to adjust the pH of the electrolyte. The conductivity of the electrolyte is measured with the Mettler-Toledo FiveGo F3 conductivity meter. All solutions are made at room temperature (~20° C.) unless otherwise specified.

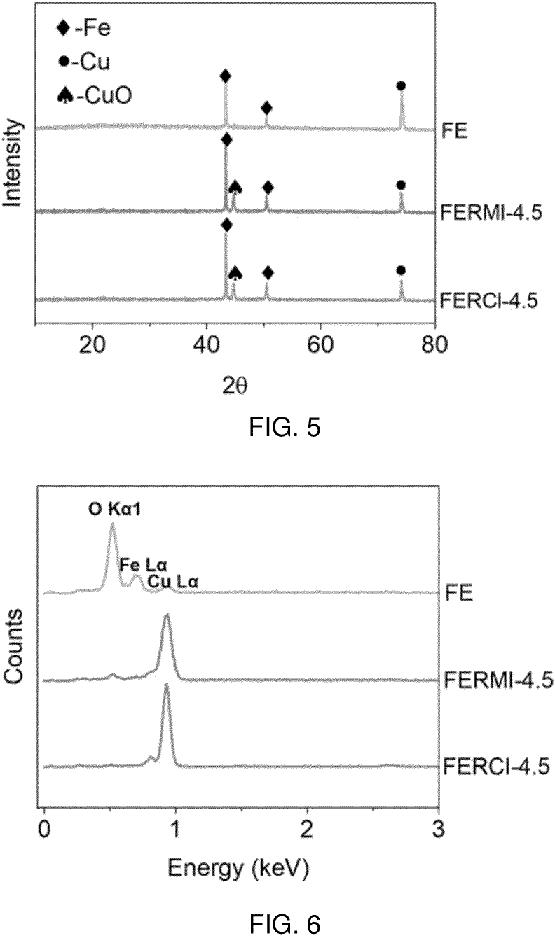

Fe deposition/stripping experiments were performed in CulFe two-electrode cells, in which a Cu foil is the substrate for Fe deposition, and a Fe foil is the Fe source. Since the standard reduction potentials of Mg²⁺, Ca²⁺ and Fe²⁺ are -2.37 V, -2.87 V, and -0.44 V vs. standard hydrogen electrode (SHE), respectively, Mg/Ca deposition is not likely to happen at the potential where Fe deposition occurs (> -0.5 V vs. Fe/Fe²⁺) This is confirmed by X-ray diffraction pattern (XRD)/Energy dispersive spectroscopy (EDS) results in FIG. 5 and FIG. 6. The XRD of deposited iron metal on the electrode in FE, FERMI-4.5, and FERCI-4.5 after the first deposition are shown in FIG. 5. The EDS of the Cu substrate after the first stripping is shown in FIG. 6. XRD patterns were obtained from a Bruker D2 Phaser with Cu Kα radiation lambda = 1.5406 Angstroms).

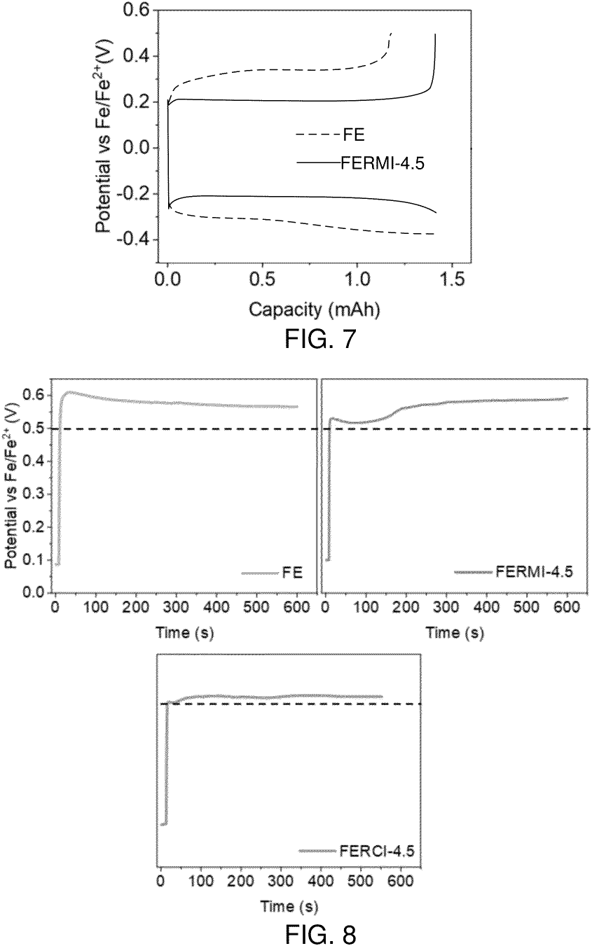

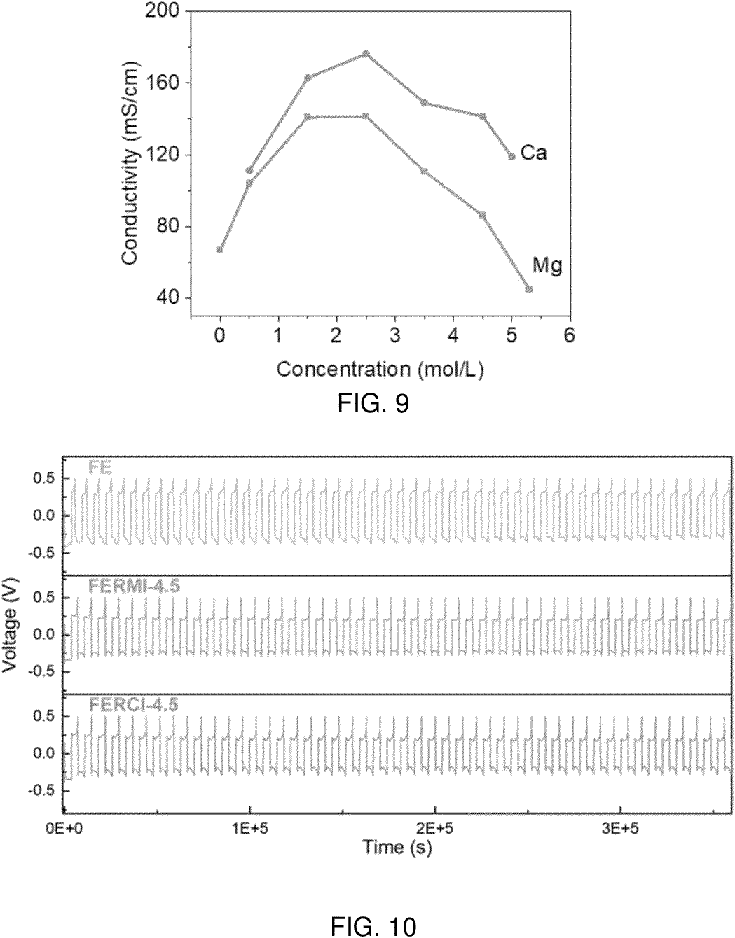

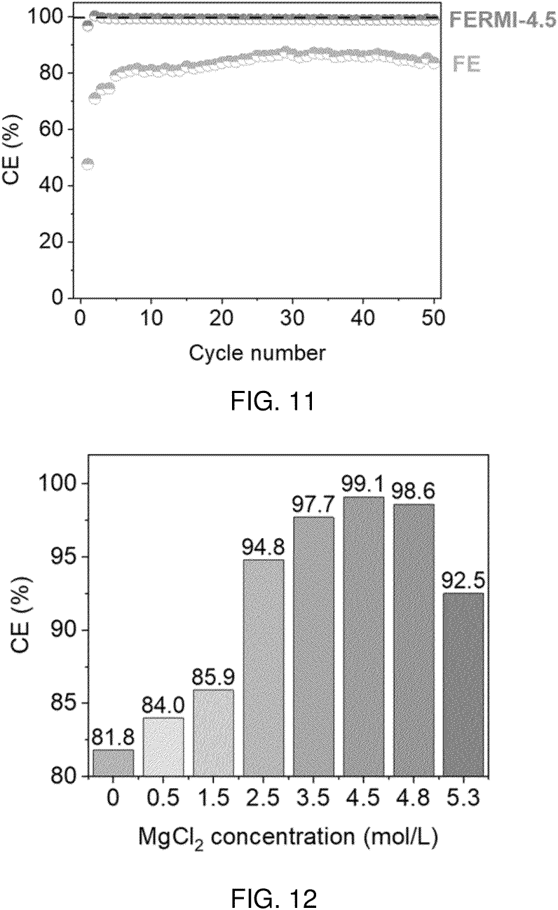

Typical potential curves for Fe deposition/stripping in FE and FERMI-4.5 are shown in FIG. 7, in which the negative potential corresponds to Fe deposition, and positive potential corresponds to Fe stripping. Typical deposition/stripping voltage curves were recorded for FE (0.5 M FeCl₂) and FERMI-4.5 (0.5 M FeCl₂+4.5 M MgCl₂) in CulFe two-electrode cells at 1 mA/cm² for 1 hour. The data of the 20th cycle is shown in FIG. 7. An upper cut-off of 0.5 V vs. Fe/Fe²⁺ is chosen during stripping to avoid the oxidation of the Cu substrate (Cu-2e⁻ = Cu²⁺) because the oxidation potential of Cu is 0.78 V vs. Fe/Fe²⁺ under standard conditions and > 0.5 V vs. Fe/Fe²⁺ in the studied electrolytes as shown in FIG. 8, which shows oxidation potentials of Cu vs. Fe/Fe²⁺ in FE, FERMI-4.5, and FERCI-4.5. The CE is calculated by dividing the oxidation capacity with respect to the reduction capacity. FERMI-4.5 not only shows improved CE compared to FE (99.1 ± 0.2% vs. 81.8 ± 7.2 %) but also increased conductivity (86.0 mS/cm vs. 66.7 mS/cm, FIG. 9 illustrates the conductivity of 0.5 M FeCl₂ with different concentrations of MgCl₂ and CaCl₂ and better deposition/stripping kinetics (total overpotential: 420 m V vs. 900 m V). The potential curves during repeated deposition/stripping cycling are shown in FIG. 10: a graph of Voltage vs. cycling time (50 cycles) of CulFe beaker cells with FE, FERMI-4.5 and FERCI-4.5; Cycling condition: 1.0 mA/cm². The CEs are shown in FIG. 11: CE vs. cycle number, in which an initial activation process is seen for both electrolytes. The initial cycle CE of FE is only 47.7%, whereas the initial cycle CE of FERMI is 96.8%. The FE reaches a stable CE of -82% after ten cycles, whereas FERMI reaches a stable CE of 99.1% only after four cycles.

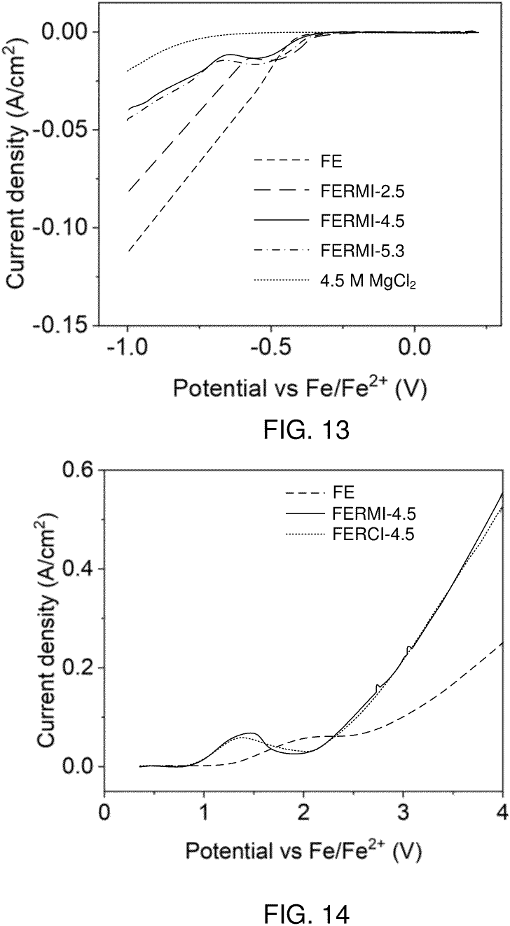

To investigate how MgCl₂ affects the Fe deposition/stripping CE, the average CEs of FERMI at different concentrations of MgCl₂ (C_{MgCl2}) are compared in FIG. 12: Average CE of FERMI-x without adjusting the pH. The average CE first increases with C_{MgCl2} and then starts to decrease after reaching a peak. A maximum CE, 99.1%, is achieved in FERMI-4.5. The non-monotonic dependence of CE on C_{MgCl2} could be related to the non-monotonic conductivity change (FIG. 9). Higher salt concentration leads to higher viscosity and lower conductivity. The associated larger overpotential leads to early termination of the stripping process, therefore, lowering the CE. The low CE of FE is in large part due to the competing HER during Fe deposition, as many gas bubbles were seen on the surface of the deposited Fe during reduction. The enhanced CE in FERMI is likely due to the suppressed HER since fewer gas bubbles were seen. To confirm this, linear scanning voltammetry (LSV) tests in a CulFelFe three-electrode cell were performed in a voltage range of 0.2 V to -1.0 V in FE, FERMI, and 4.5 M MgCl₂ (FIG. 13: Linear scan voltammetry of FE, 4.5 M MgCl₂ and FERMI-x electrolytes in CulFelFe three-electrode cell at 10 mV/s in the range of -1.0 V to 0.2V vs. Fe reference electrode (RE)). In FE, the peak for Fe²⁺ reduction is not visible due to the strong HER For FERMI-2.5, the Fe²⁺ reduction peak becomes visible, and the HER current reduces. For FERMI-4.5, the HER current further decreases. The HER current in FERMI-4.5 is only -0.075 mA/cm² at -1.0 V, which is three times smaller than that in FE, suggesting the HER is suppressed in FERMI. For FERMI-5.3, the HER current slightly increases compared to FERMI-4.5. The dependence of HER suppression on Mg²⁺ concentration is consistent with the observed CE, confirming the suppression of HER is a main reason for the increased CE in FERMI. LSV results in an anodic scan show that in the FERMI/FERCI, the Fe²⁺/Fe³⁺ redox peak has less overlap with the oxidation of the chloride solution than in the FE (FIG. 14), which is beneficial for achieving high cathode CE in an all-Fe flow battery.

For the above tests, the cells were assembled in two-electrode cells by using a copper disc as the working electrode and a Fe foil as the counter electrode. The electrochemical test was carried out with a NEW ARE Battery Testing System. In Cu||Fe cells, a given amount of charge (Qd, 1 mAh/cm² was passed to deposit Fe on the Cu substrate. Then a constant current is applied to strip the Fe deposits until the voltage reaches a cut-off voltage of 0.5 V. The stripping capacity Qs of every cycle is recorded. The CE of each cycle is calculated by dividing the stripping capacity by the deposition capacity. The average CE for the whole cycling process is calculated by dividing the total stripping capacity by the total deposition capacity. LSV was carried out on a copper disc in a three-electrode cell with a Fe foil as the reference electrode and another Fe foil as the counter electrode at a scan rate of 10 mV/s.

FIG. 14 shows linear scan voltammetry of FE, FERMI-4.5, FERCI-4.5 electrolyte in carbon felt|Fe|Fe three-electrode cell at 10 mV/s in the range of 0.4 V to 4.0 V vs. Fe RE. The oxidation of the chloride solution can generate oxygen or chlorine. The standard reduction potential of Fe²⁺/Fe³⁺, H₂O/O₂ and Cl⁻/Cl₂ are 0.771, 1.229 and 1.396V vs SHE, respectively, or 1.211, 1.669 and 1.836 vs. Fe/Fe²⁺, respectively, which suggests under the standard condition the oxidation of Fe²⁺ is thermodynamically more favorable than the oxidation of the chloride solution. This trend is in general consistent with experimental observations, in which the Fe²⁺/Fe³⁺ precedes the oxidation of the solution. The redox peak of Fe²⁺/Fe³⁺ overlaps with that of the solution in FE, whereas they are more separated in FERMI and FERCI. This difference could be attributed to the improved kinetics of Fe²⁺/Fe³⁺, as its redox potential in FERMI and FERCI is closer to its thermodynamic value (1.211 V vs. Fe/Fe²⁺) than in FE.

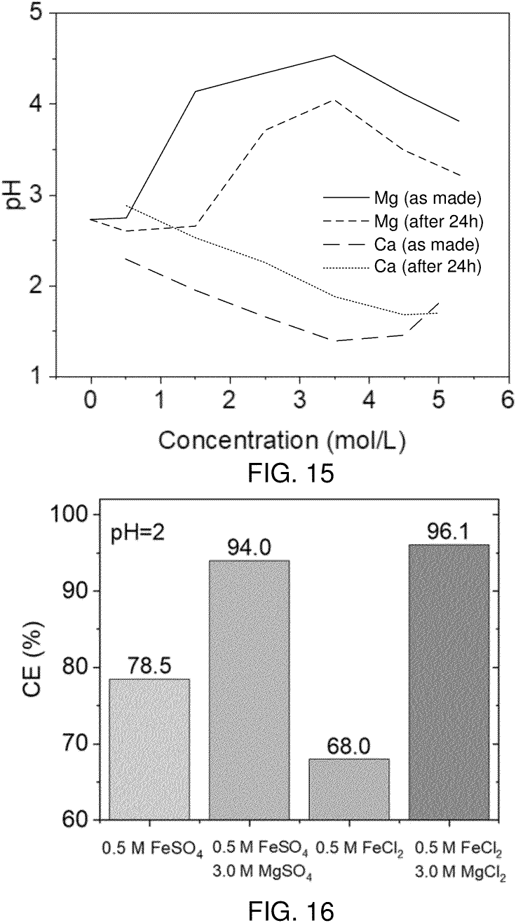

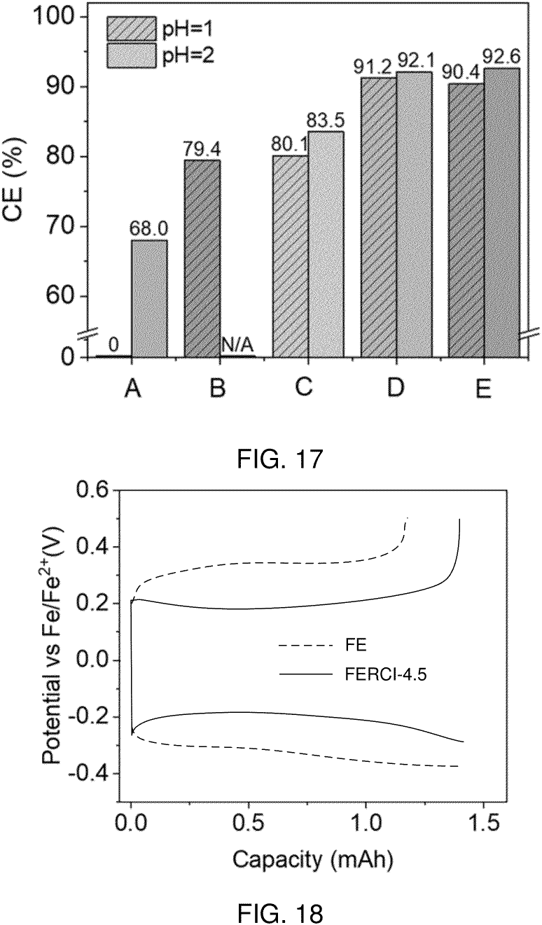

When dissolving MgCl₂ into FE, the pH of the solution slightly increases (pH of FE=2.7, pH of FERMI-4.5=4.1) (FIG. 15), which can mitigate HER due to reduced proton concentration. FIG. 15 shows a graph of pH of 0.5 M FeCl₂ with different concentrations of MgCl₂ and CaCl₂. The pH of a solution of Fe²⁺ is dependent on the equilibrium of the hydrolysis of Fe²⁺, Fe²⁺ + H₂O = FeOH⁺ + H⁺, and FeOH⁺ + H₂O = Fe(OH)₂ + H⁺. After dissolving Mg2⁺ or Ca²⁺ into the 0.5 M FeCl₂ solution, they may affect the hydrolysis equilibrium of Fe²⁺. Specifically, Mg²⁺ drives the hydrolysis so the solution becomes more acidic, which is evidenced by the precipitation of Fe(OH)₂ after 24 hours, while Ca²⁺ suppresses the hydrolysis, so the solution becomes more basic. The difference between Mg²⁺ and Ca²⁺ could be due to the stronger basicity of Ca²⁺ (pKa=12.8) than Mg²⁺(pKa=1 1.3). In addition, the increased concentration of Cl⁻ can also suppress HER due to its preferential adsorption to the electrode surface. To examine only the effect of Mg²⁺, two additional experiments were performed. First, FE made with FeCl₂ and FeSO₄ are compared with the FERMI with the same anion at the same pH (pH = 2) (FIG. 16: Average CE of FE with Cl⁻ and SO₄²⁻·, the corresponding FERMI at pH=2. Here only 3.0 M Mg²⁺ is used since the solubility of MgSO₄ is 3.2 M). A clear increase in CE (28.1 % for Cl⁻, 15.5% for SO₄²⁻) is observed when 3.0 M Mg salts are added into FE, irrespective of the anion. This result suggests the effect of Cl⁻ on CE is likely to be secondary. Second, Fe electrolytes with the same amount of Cl⁻ but distinct types of cations (Fe²⁺, Na⁺ and Mg²⁺) are compared at the same pH (FIG. 17: Average CE of A (FE), B (FE+2.5 M FeCl₂ (3.0 M FeCl₂)), C (FE+5.0 M NaCl), D (FE+2.5 M MgCl₂) and E (FE+2.5 M CaCl₂) at different pHs, 3.0 M FeCl₂ has a pH= 1, and increasing its pH leads to precipitation of Fe(OH)₂. Therefore, the efficiency of 3.0 M FeCl₂ at pH=2 is not available. The reason to choose pH=1 and 2 for this comparison is that Fe²⁺ will precipitate as Fe(OH)₂ when solution pH> 2.7 (the as-made 0.5 M FeCl₂ has a pH=2.7), and Fe³⁺ will precipitate as Fe(OH)₃ when solution pH >1.2 (the as-made 0.5 M FeCl₃ has a pH= 1.2) Note at pH= 1, there is no reversible Fe deposition/stripping in FE due to the strong acidity of the electrolyte, so the CE is zero). A total Cl⁻ concentration of 6.0 M was selected to compare the effect of different cations because the solubility of NaCl is 5.5 M and the solubility of FeCl₂ is 3.57 M. At pH= 1, the CE of FE is zero, because at such a high H⁺/Fe²⁺ molar ratio (0.1 M / 0.5 M=0.2), Fe²⁺ reduction fails to compete with H⁺ reduction, so HER dominates. The CE increases to 79.4% if an additional 2.5 M FeCl₂ is added into FE (3.0 M FeCl₂). When comparing the electrolytes with the same Cl⁻ concentration (6.0 M) but different cations, electrolytes containing Mg²⁺ show better CE than those containing Na⁺ and Fe²⁺ at both pH=1 and 2. As for the pH effect, electrolytes containing both Mg²⁺and Na⁺ show only a slight increase (0.9-3.4%) in CE when pH is increased from 1 to 2. In summary, these results demonstrate that 1) Mg²⁺ can enhance CE regardless of the type of anion and electrolyte pH and 2) the significant increase of CE in FERMI is to be primarily due to the presence of Mg²⁺ whereas pH and Cl⁻ only play minor roles.

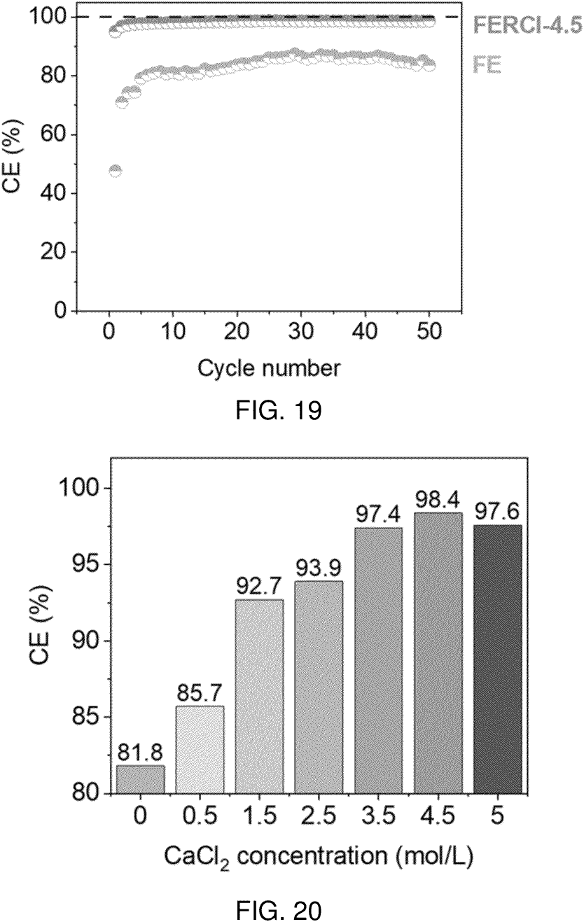

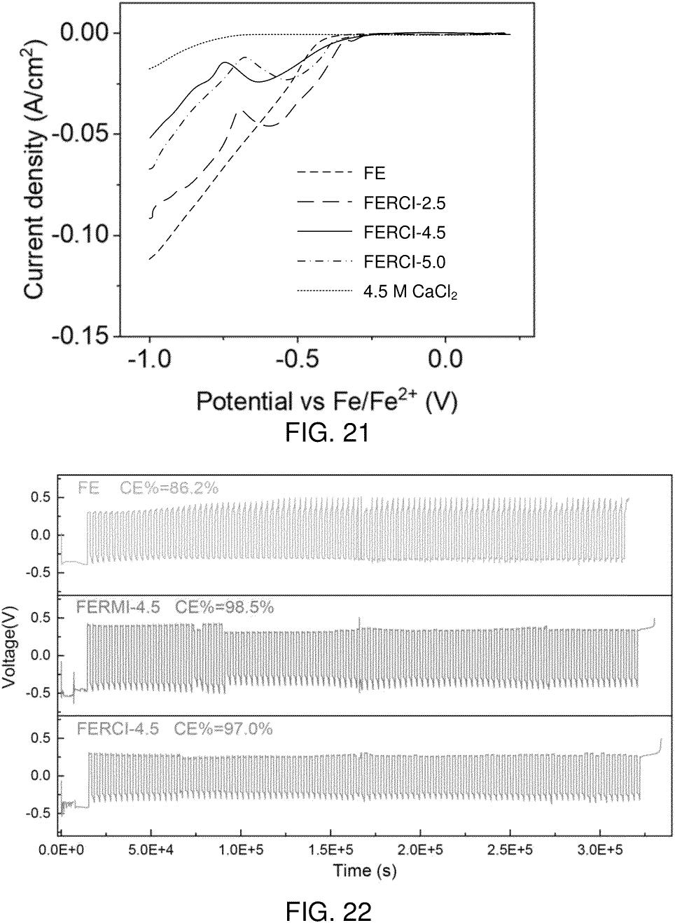

A similar enhancement of Fe deposition/stripping efficiency can also be achieved with Ca²⁺. The typical potential curves for Fe deposition/stripping in FE and FERCI are compared in FIG. 18 (Typical deposition/stripping voltage curves for FE and FERCI-4 in CulFe two-electrode cells at 1 mA/cm² for 1 hour. The data of the 20th cycle is shown here), and the CEs during cycling are compared in FIG. 19 (Coulombic efficiency vs. cycle number). Like FERMI, the FERCI-4.5 shows a stable CE of 98.4 ± 0.48 % after the initial activation cycles. The CE of FERCI at different Ca²⁺ concentrations is shown in FIG. 20 (Average CE of Fe electrolytes at different CaCl₂ concentrations), and a maximum CE of 98.4% is achieved for FERCI-4.5. The LSV results of FE, FERCI, 4.5 M CaCl₂ are compared in FIG. 21 (Linear scan voltammetry of FE, 4.5 M CaCl₂ and FERCI-x electrolyte in CulFelFe three-electrode cell at 10 mV/s in the range of -1.0 V to 0.2 V vs. Fe RE). FERCI and 4.5 M CaCl₂ show similar HER suppression effect: the peak HER current at-1.0 V drops from -0.22 mA/cm² in FE to -0.10 mA/cm² in FERCI-4.5. In addition, the dependence of HER suppression on Ca²⁺ concentration is consistent with the CE’s dependence. These results demonstrate Ca²⁺ can also improve Fe deposition/stripping efficiency by suppressing HER To confirm the enhancement of CE in FERMI and FERCI, the CE for iron deposition/stripping is measured with another method, as shown in FIG. 22. This figure includes graphs of voltage profiles during the cycling of a CulFe beaker cell. Given the amount of charge (Q_{T}, 4 mAh cm⁻²) was employed to deposit Fe on Cu foil. Next, a smaller capacity (Qc, 0.4 mAh cm⁻²) was used to cycle for 100 cycles. Finally, the remaining of the Fe reservoir was exhaustively stripped to the cut-off potential, obtaining the final stripping charge capacity of Qs. Thus, the average CE can be calculated by:

$$C E = \frac{100 ∗ {Q}_{c} + {Q}_{S}}{100 ∗ {Q}_{c} + {Q}_{T}}$$

As can be seen, the efficiency increases significantly after adding Ca²⁺ or Mg²⁺, which validates the enhancement of CE regardless of the methods used for measuring the efficiency.

To further understand the enhanced CE in FERMI and FERCI, scanning electron microscope (SEM) images of Fe deposits after the first deposition in FE, FERMI-4.5, and FERCI-4.5 were compared. SEM images and Energy dispersive spectroscopy (EDS) were collected on the FEI Quanta 600 SEM. The deposits in FE are loosely connected flower-like assembly of nanosheets, whereas the deposits in FERMI and FERCI are compactly stacked micron-sized and sub-micron-sized particles. The deposits in FE have a larger surface area to volume ratio than those in FERMI and FERCI, which provide more sites for HER to occur. XRD of the deposits in these electrolytes is shown in FIG. 5. Strong Fe signals can be seen in all of them, suggesting the excellent crystallinity of Fe deposits. The presence of CuO and weakened Cu signal in FERMI-4.5 and FERCI-4.5 is likely a result of the chemical corrosion of the Cu substrates by Cl⁻. The chemical corrosion of Cu in chlorine solution is well-known and can be described by Cu+H⁺+2Cl⁻=0.5 H₂+CuCl₂⁻. Note the electrochemical oxidation of Cu cannot explain this phenomenon because the working electrode is in a reductive environment during the Fe depositing process. The chemical corrosion does not intervene the calculation of the coulombic efficiency because the electron transferred from Cu to H⁺ does not go through the external circuit therefore it is not counted by the potentiostat during the iron deposition/stripping experiment. SEM images of the Cu substrates after the first stripping were also compared. Many fluffy clusters of a few microns in size and large quantities of nanoparticles exist on the surface of the Cu substrate in FE. Its EDS shows a strong signal of Fe Lα (FIG. 6), suggesting these clusters and nanoparticles are unreacted Fe during the stripping process, i.e., “dead Fe”.

TABLE 1

EDS analysis of Cu substrates from FE, FERMI-4.5, FERCI-4.5 after the first stripping.
FE

| Element | Weight% | Atomic % | Error % |
|---|---|---|---|
| OK | 53.36 | 80.43 | 5.06 |
| Fe L | 35.65 | 15.4 | 10.17 |
| CuL | 10.99 | 4.17 | 21.81 |
| FERMI-4.5 | | | |
| Element | Weight% | Atomic% | Error% |
| OK | 3.69 | 13.47 | 11.46 |
| Cu L | 93.19 | 85.71 | 2.99 |
| FERCI-4.5 | | | |
| Element | Weight% | Atomic % | Error % |
| Cl K | 2.6 | 4.5 | 15.9 |
| Ca K | 2.2 | 3.3 | 19.7 |
| Fe K | 2.3 | 2.5 | 25.6 |
| Cu K | 93 | 89.7 | 5.3 |

Such “dead metal” is observed in the stripping of electrochemically deposited metals, such as Li and Na. It occurs when metal deposits are electrically isolated from the substrate during the stripping process, which is common for deposits with skinny morphology. The weak signal of Cu Lα indicates the “dead Fe” covers most of the Cu substrate. The strong 0 Ka1 signal is likely due to the oxidation of the dead Fe during sample preparation. In stark contrast, much less “dead Fe” is observed on the Cu substrates in FERMI-4.5 and FERCI-4.5, and EDS shows a strong sign of Cu Lα but no clear sign of Fe Lα, confirming there is little “dead Fe” on the Cu substrates. The strong signal of Cu and the absence of anion signals (Cl and O) also suggest no solid electrolyte interface (SEI) forms on the Cu substrate since SEI should contain compounds of the corresponding ions in the electrolyte. Mg and Ca or their oxides/hydroxides are not observed in both the XRD and EDS results, confirming Mg/Ca deposition does not occur in these electrolytes. In summary, these results demonstrate 1) only Fe deposition occurs in FERMI and FERCI, 2) they promote the growth of large and compact Fe deposits, and 3) they reduce the amount of “dead Fe” during the stripping process. The better Fe deposits morphology and less “dead Fe” in FERMI and FERCI is another reason for the better Fe deposition/stripping efficiency.

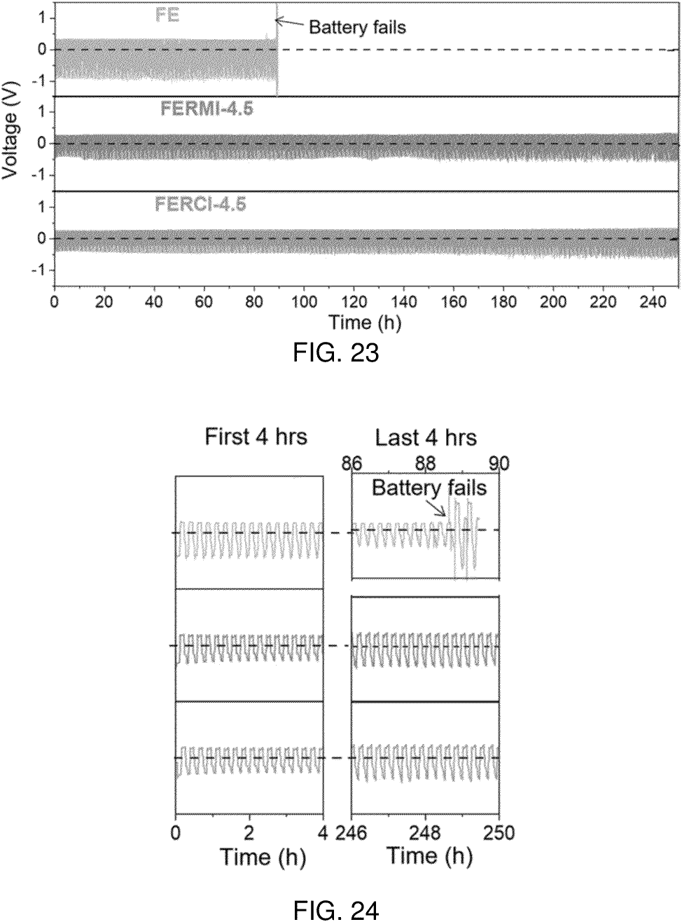

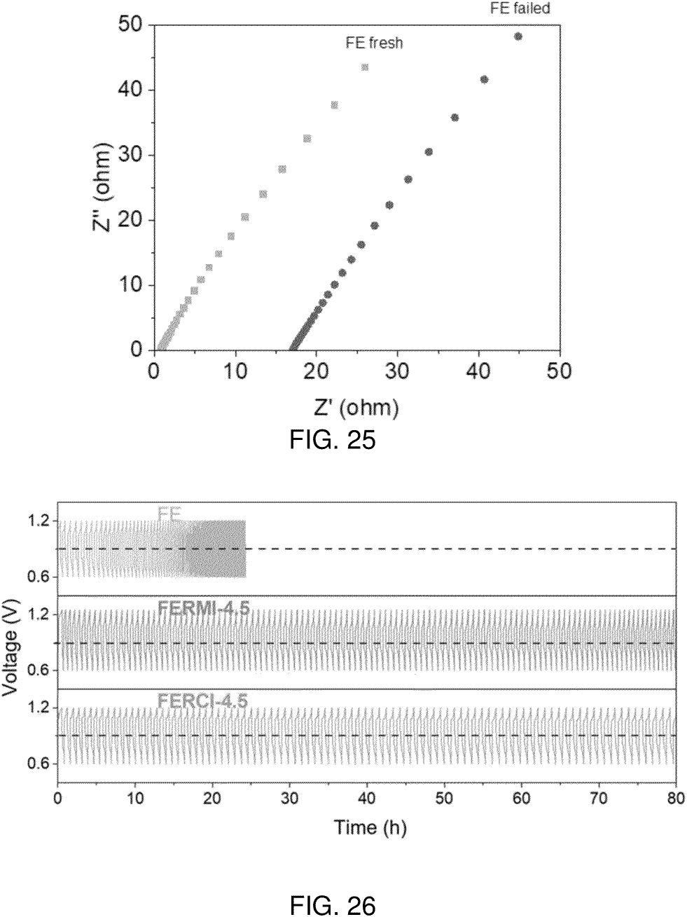

To demonstrate how the Fe deposition/stripping efficiency affects Fe metal battery’s cycle life, cycling experiments were performed with Fe|Fe symmetrical cells and LiFePO₄|Fe full-cells. The cycling performance was measured in coin cells made by using a Fe foil as the counter electrode, another Fe foil as the working electrode, and glass fiber as the separator. During cycling, side reactions, including HER, will change the electrolyte’s chemistry over time and eventually fail the cell. The Fe|Fe symmetrical cells were cycled by charging for 0.1 hours and then discharging for another 0.1 hours both at 1.0 mA/cm² without constraining the voltage. The voltage profiles during cycling are compared in FIG. 23 and FIG. 24. FIG. 23 illustrates cycling performance of Fe|Fe symmetric cells in FE, FERMI-4.5 and FERCI-4.5, in particular voltage vs. cycling time with the cycling condition of 1.0 mA/cm². FIG. 24 is a zoom-in view of the first and last four hours of the cycling results. The cells with FE can work for 88.5 hours, and then the cells fail signaled by a sudden increase voltage, which is caused by an increase in internal cell resistance from 0.86 Ω to 17.1 Ω (FIG. 25: a graph of EIS results of as-made and failed Fe|Fe coin cells with 0.5 M FeCl₂). The failed coin cells swelled, indicating the generation of a large amount of gas inside the cell. After dissembling the failed cells, the electrolyte almost dried out, and green precipitate can be found on the spacer. These results suggest the internal resistance increase can be attributed to 1) the generated gas bubbles block the ion transport pathway between the working and counter electrodes 2) HER consumes water and leads to an increase of electrolyte viscosity and 3) pH increase and the precipitation of Fe salts. In contrast, the cell with FERMI-4.5 and FERCI-4.5 can work for >250 hours with no significant increase in voltage. Similar results were observed in CulFe cells as well. To further demonstrate how the improved Fe anode CE affects the Fe metal battery’s cycle life, LiFePO₄|Fe full cells with FE, FERMI-4.5, and FERCI-4.5 were assembled and tested. The working electrode comprised 80 wt% LiFePO₄ active mass, 10 wt% Ketjen black carbon, and 10 wt% polyvinylidene fluoride (PVDF) binder. The slurry of the working electrodes was cast on carbon felt. The cycling performance was measured in coin cells made by using a Fe foil as the counter electrode, a carbon felt disk (3 mm thick) loaded with LiFePO₄ as the working electrode, and a Daramic membrane as the separator. No spring is used in the coin cell. Instead, a carbon felt disk is placed on top of the working electrode to ensure enough pressure inside the coin cell and to ensure that the chloride electrolyte does not contact the upper cell case. 0.5 M LiCl is added into each electrolyte to ensure the reversible charge/discharge of the LiFePO₄ cathode. All coin cells were crimped by the MSK-110 hydraulic crimping machine. The test was also carried out with NEW ARE Battery Testing System.

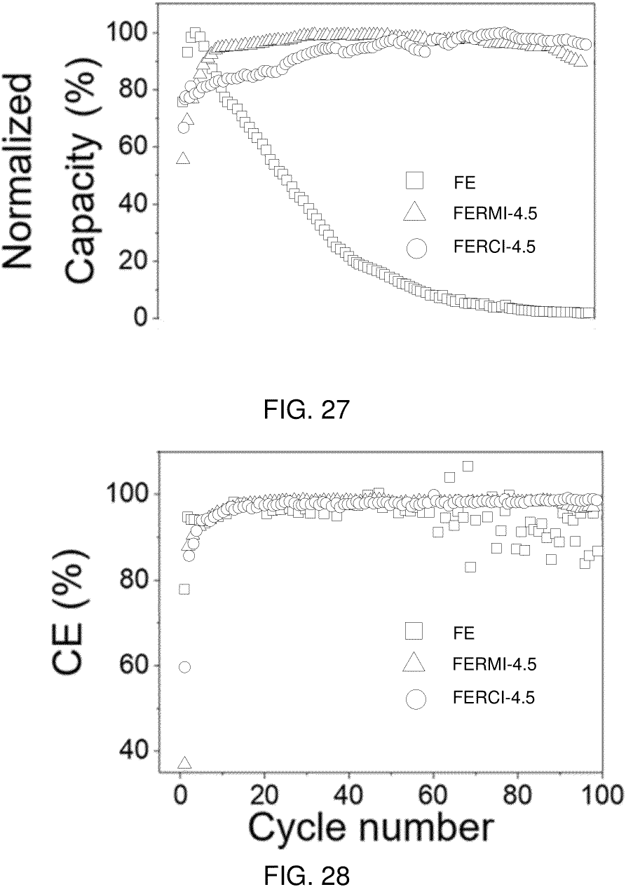

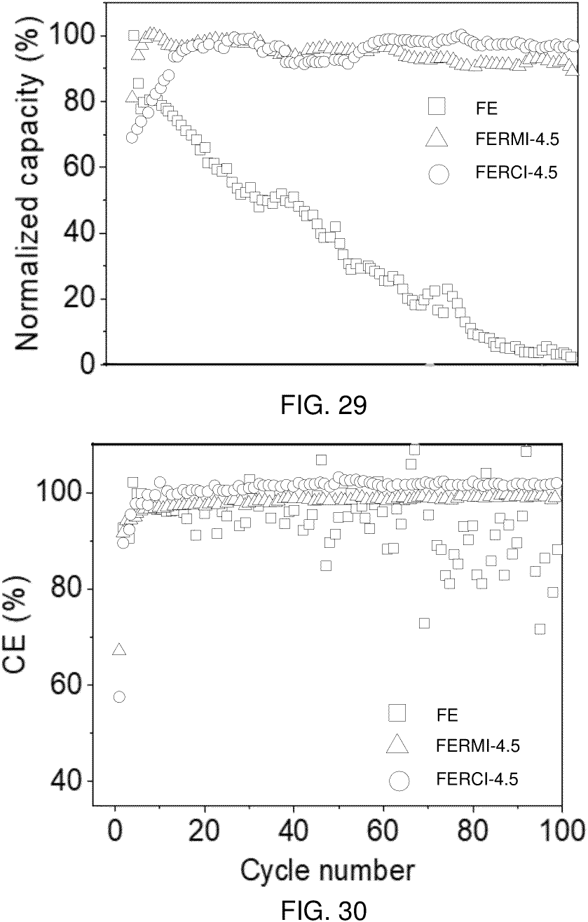

The cells were charged/discharged at 1.0 mA/cm² in the voltage range of 0.60-1.25 V. The voltage profiles during cycling, are compared in FIG. 26. The cell with FE fails rapidly within the first 20 hours, whereas the cells with FERMI-4.5 and FERCI-4.5 can operate for over 80 hours without clear signs of degradation. The normalized capacity and CE are compared in FIG. 27 and FIG. 28, respectively. Cells undergo an activation process before reaching the maximum capacity, which could be attributed to the slow wetting of aqueous electrolytes to the graphite felt current collector. The cell with FE fades rapidly and loses 97.7% of the capacity at the 100th cycle, whereas cells with FERMI-4.5 and FERCI-4.5 show very stable cycling and lose only 11.2% and 4.67% of the capacity at the 100th cycle. Meanwhile, the cell with FE shows an average CE of 95.2%, whereas the cells with FERMI and FERCI show average CEs of 97.7% and 97.2%, respectively. The cycling performances and CEs of LiFePO₄|Fe full cells in FE, FERMI-4.5 and FERCI-4.5 with no Li salts are given in FIG. 29 and FIG. 30. Cells with FERMI-4.5 and FERCI-4.5 show much stabler cycling than cells with FE, which is consistent with FIG. 27 and FIG. 28. In summary, these results demonstrate that the enhanced Fe anode efficiency in FERMI and FERCI can significantly boost the cycling performance of both Fe metal batteries in half-cells and full-cells.

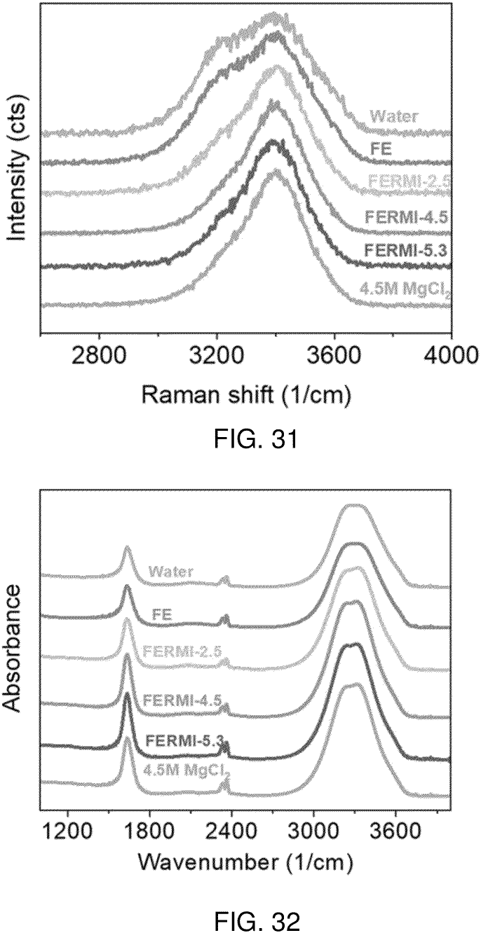

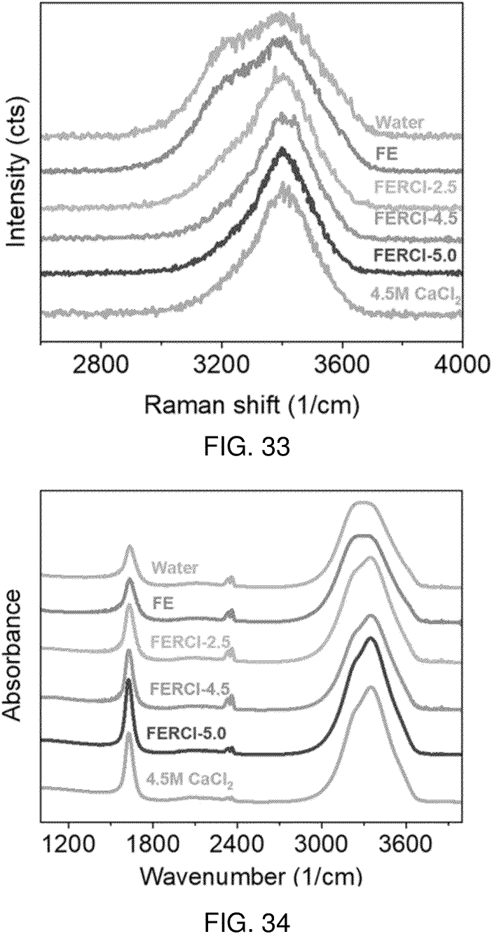

To understand the effect of Mg²⁺ and Ca²⁺ in the Fe electrolytes, Raman and Fourier transform infrared (FTIR) spectra of FE, FERMI, and FERCI were collected and compared. Raman spectrums of electrolytes were collected with Witec alphasnom Confocal Raman. FIG. 31 is a graph of intensity for Mg²⁺ electrolytes. FIG. 32 is a graph of absorbance for Mg²⁺ electrolytes. FIG. 33 is a graph of intensity for Ca²⁺ electrolytes. FIG. 34 is a graph of absorbance for Ca²⁺ electrolytes. In aqueous electrolytes, the water interacts strongly with the ions by electrostatic interaction, H-bonding or charge transfer. The orientation, H-bonding, and vibrational dynamics of water in the hydration shell are very different from the bulk water. Water can form a maximum of four H-bonds with its neighboring water molecules by donating two protons and accepting two protons to the lone pair of electrons on oxygen. Based on how strongly a water molecule participates in H-bond formation, four types of water are possible at ambient temperature. In the order of decreasing number of H-bond, they are DDAA, DDA, DAA, and DA, in which D refers to water molecules donating a proton, and A refers to water molecules accepting a proton (i.e., DDA means double donor-single acceptor). In the Raman spectroscopy of pure water, the OH symmetric stretch region has a broad peak with three bands at -3200 cm·1, -3400 cm·1 and -3600 cm·1, which can be assigned to DDAA water, DA water and DDA water, respectively. In FE, the molar ratio of H₂O to Fe²⁺ is 105 (Table 2).

TABLE 2

Conductivity, pH and the molar ratio of water to Mg or Ca in 0.5 M 15 FeCl₂ with different concentrations of MgCl₂ and CaCl₂.

| MgCl₂ (mol/L) | pH (as-made) | pH (after 24h) | Conductivity (mS/cm) | Molar ratio water/Mg²⁺ | Molar ratio water/Fe |
|---|---|---|---|---|---|
| 0.00 | 2.73 | 2.73 | 66.68 | | 105.00 |
| 0.50 | 2.74 | 2.60 | 103.80 | 103.89 | 103.89 |
| 1.50 | 4.14 | 2.65 | 140.90 | 33.78 | 101.33 |
| 2.50 | 4.34 | 3.71 | 141.50 | 20.16 | 100.78 |
| 3.50 | 4.38 | 3.16 | 110.70 | 1..30 | 93.11 |
| 4.50 | 4.11 | 2.54 | 85.98 | 10.36 | 93.22 |
| 5.30 | 3.82 | 3.23 | 44.75 | 8.65 | 91.67 |
| 0.00 | 2.73 | 2.73 | 66.68 | | 105.00 |
| 0.50 | 2.30 | 2.89 | 111.30 | 109.00 | 109.00 |
| 1.50 | 1.96 | 2.54 | 162.80 | 34.93 | 104.78 |
| 2.50 | 1.67 | 2.27 | 176.20 | 20.31 | 101.56 |
| 3.50 | 1.39 | 1.89 | 148.90 | 13.98 | 97.89 |
| 4.50 | 1.46 | 1.69 | 141.40 | 10.48 | 94.33 |
| 5.00 | 1.81 | 1.71 | 118.90 | 9.48 | 94.78 |

Since Fe²⁺ prefers octahedron coordination, there are at most six water molecules in its hydration shell so that most water molecules exist in bulk. Therefore, the Raman spectroscopy of FE is close to pure water. Nonetheless, the water structure changes significantly after adding Mg²⁺ or Ca²⁺. Due to the high charge density of Mg²⁺ and Ca²⁺, its influence on water structure and dynamics extends beyond the first hydration shell. In dilute electrolyte, both Mg²⁺ and Ca²⁺ immobilize ~20 water molecules, forming two hydration shells around them, with the first hydration shell containing six water molecules for Mg²⁺ and 6-9 water molecules for Ca²⁺. Upon increasing the concentration of Mg²⁺/Ca²⁺, the number of water molecules in the hydration shell of Mg²⁺/Ca²⁺ increases proportionally for up to a certain concentration (2.0 M for Mg²⁺, in which the molar ratio of water and Mg²⁺ are ~25). Further increasing the concentration of Mg²⁺/Ca²⁺, solvent separated ion pairs (2SIP), or even solvent shared ion pairs (SIP) can form. At 4.5 M Mg²⁺/Ca²⁺, the molar ratio of H₂O to Mg²⁺/Ca²⁺ is ~10, suggesting that all water molecules exist in the hydration shells of Mg²⁺/Ca²⁺, and a portion of these hydration shell water is shared with Cl⁻. In the hydration shells, the O atoms of water point toward Mg²⁺/Ca²⁺ and H atoms point away. For water molecules shared with Cl⁻, their H atoms point toward the Cl⁻. Due to this orientation preference and geometric constraint, hydration shell water forms fewer H-bonds than bulk water. Therefore, the presence of a large amount of Mg²⁺/Ca²⁺ disrupts water structure and eliminates strong hydrogen-bonded water. Previous studies show the ~3600 cm⁻¹ band and ~3200 cm⁻¹ band in the Raman spectroscopy weakens as 1.0-2.0 M Mg²⁺/Ca²⁺ is added. Here, a similar weakening effect is observed at 2.5 M of Mg²⁺/Ca²⁺. These two bands completely disappear at 4.5 M of Mg²⁺/Ca²⁺ and further increasing Mg²⁺/Ca²⁺ concentration results in no observable change. These results indicate adding 4.5 M Mg²⁺/Ca²⁺ eliminates DDA water and DDAA water, which leads to fewer H-bonds per water. Similar suppression of the ~3200 cm⁻¹ band is also observed in the OH-stretching region of the FT-IR spectra of FERMI and FERCI. The intensity of the O-H-O bending vibration peak at 1600 cm⁻¹ grows with increasing Mg²⁺/Ca²⁺ concentration, also indicating the weakening of the H-bond. In addition to the change in water structure, the hydration shell of Fe²⁺ also changes after adding Mg²⁺/Ca²⁺. In FE, Fe²⁺ mostly exists as [Fe(H₂O)6]²⁺ in an octahedral configuration. Given the ratio of Fe²⁺/H₂O decreases in FERMI and FERCI, the salvation shell of Fe²⁺ will have fewer water molecules and more Cl⁻. A similar effect has been observed for Zn²⁺ when less water is available. The computational study below elucidates this change in the Fe²⁺ solvation shell.

### Example 2: Comparison of FE Battery With FERCI-4.5 Batteries

Fe redox flow batteries were constructed with different electrolytes. One battery used an electrolyte containing 0.5 M FeCl₂ alone. Another battery used an electrolyte containing 0.5 M FeCl₂ and 4.5 M CaCl₂. The last battery used an electrolyte containing 0.5 M FeCl₂ and 4.5 M CaBr₂. Each of the batteries used an Fe metal anode and Fe²⁺/Fe³⁺ as the cathode.

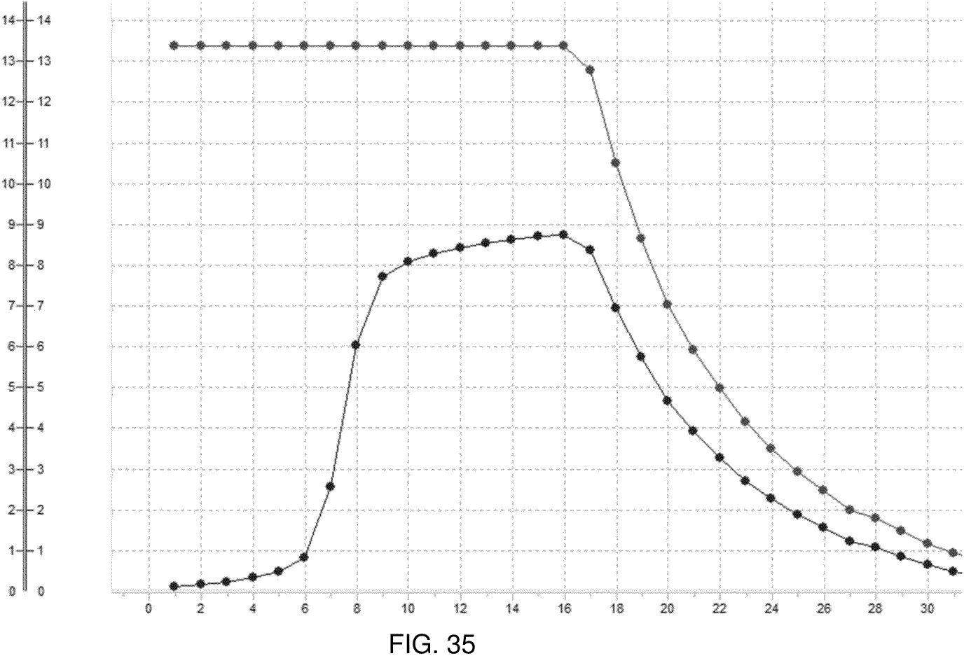

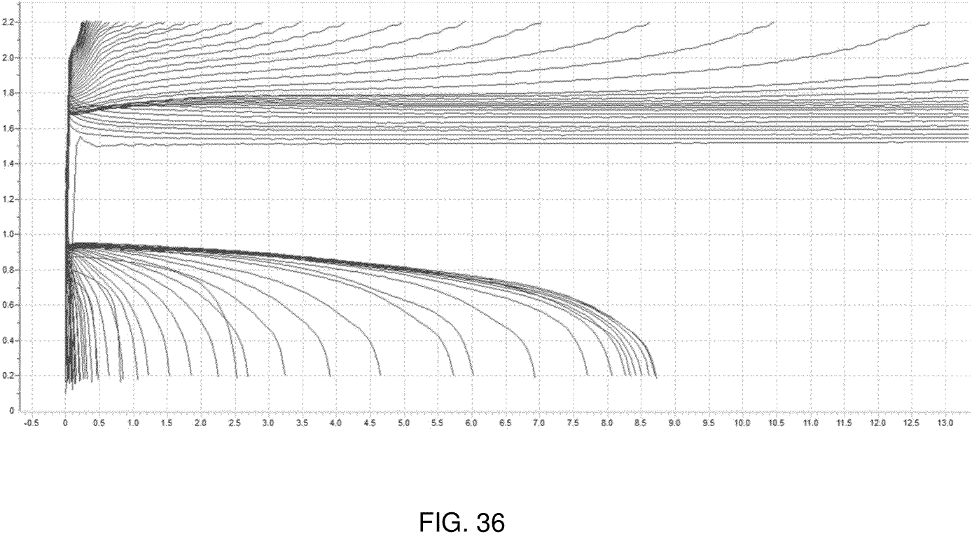

The batteries were charged and discharged for a number of cycles. The capacity of the batteries was measured during each cycle. The charge and discharge profile of the batteries were also record during each cycle. FIG. 35 is graph of battery capacity (y-axis, in mAh) vs. cycle number (x-axis) for the battery with 0.5 M FeCl₂ alone (FE battery). The top line shows the delivered capacity of the battery while discharging, while the bottom line is the discharge capacity. The FE battery was charged and discharged only 16 times before severe performance decay occurred. FIG. 36 shows voltage (y-axis) vs. delivered capacity (x-axis, in mAh) for the FE battery. The widely spread-out lines on this graph show that the battery suffers from a rapid loss of capacity and voltage.

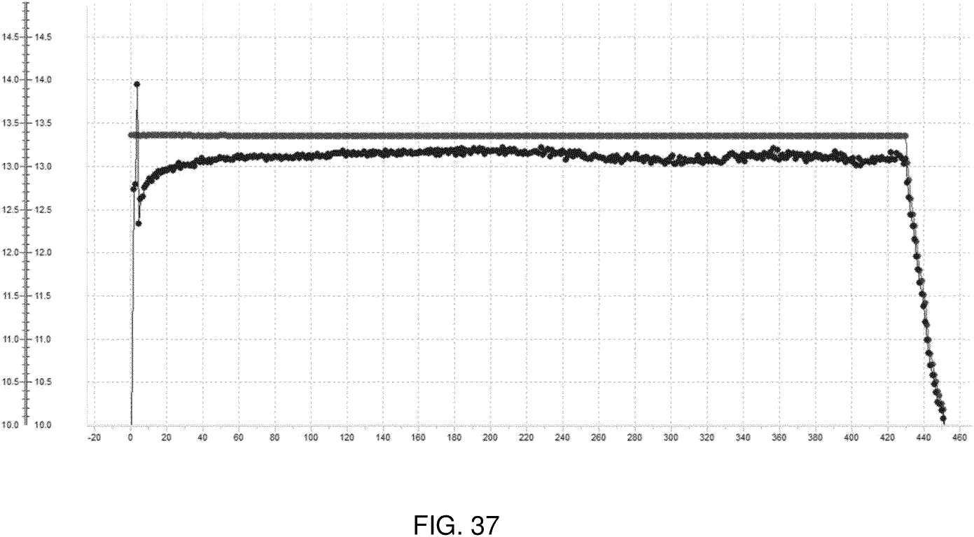

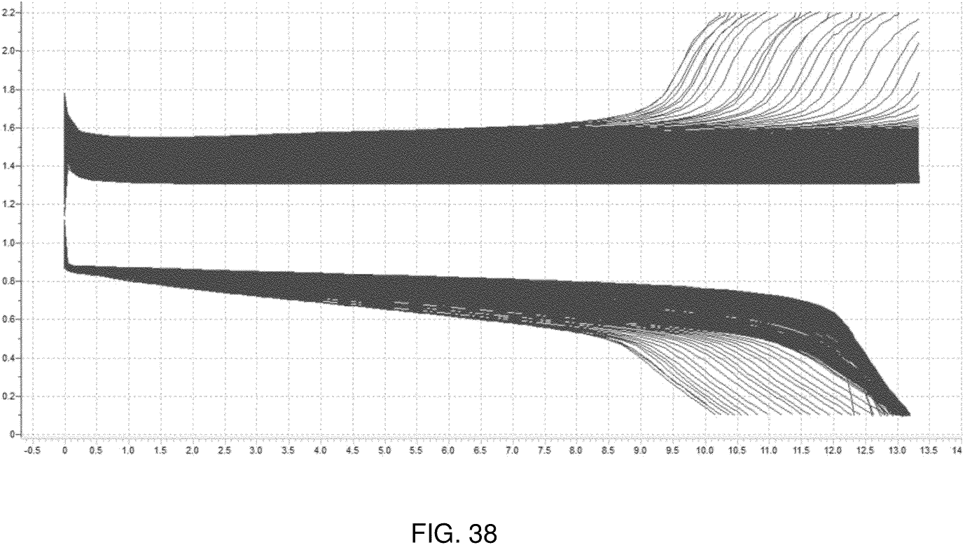

FIG. 37 is a graph of battery capacity vs. cycle number for the battery with 4.5 M CaCl₂ electrolyte (CaCl₂ battery). This battery had a stable capacity for 430 cycles before the performance decayed. FIG. 38 is a graph of the voltage vs. delivered capacity. The lines on this graph are much more closely packed compared to FIG. 36, which shows that this battery loses voltage and capacity much slower than the FE battery.

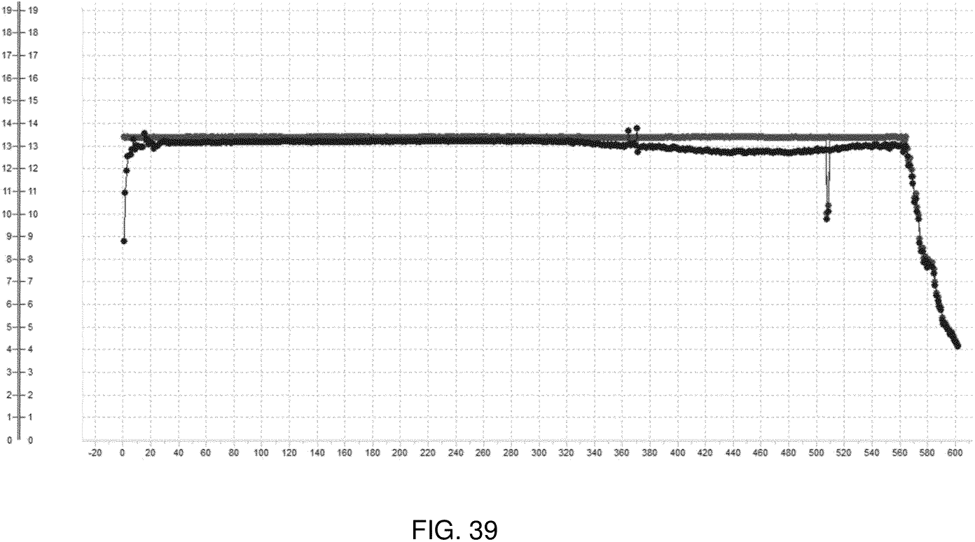

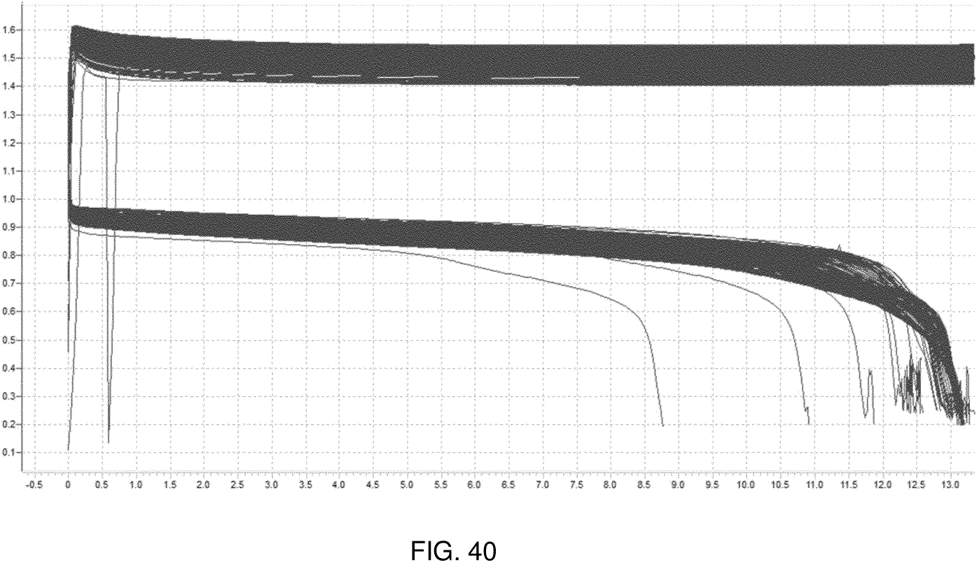

FIG. 39 is a graph of battery capacity vs. cycle number for the batter with 4.5 M CaBr₂ electrolyte (CaBr₂ battery). This battery had a stable capacity for 580 cycles before performance decay occurred. FIG. 40 is a graph of voltage vs. delivered capacity. The lines in this graph are very closely packed, showing that almost no voltage and capacity is lost during the 580 cycles. These results show that the electrolytes including calcium cations allowed the Fe battery to operate for many more cycles than the Fe battery with FeCl₂ alone.

### Example 3: Simulations

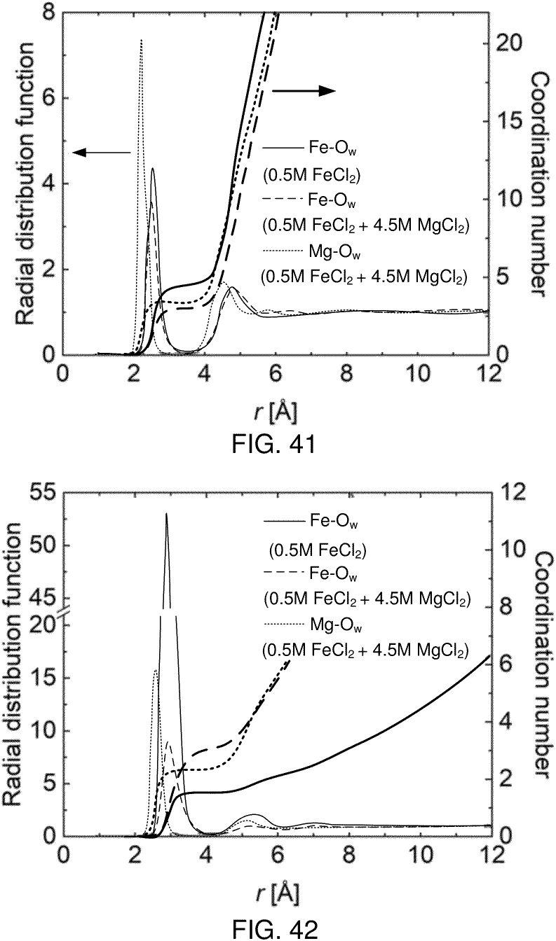

To further understand the electrolyte structure, atomistic molecular dynamics (MD) simulations using polarizable force field (APPLE&P) were performed for FE (0.5 M FeCl₂) and FERMI-4.5 (0.5 M FeCl₂ +4.5 M MgCl₂) at room temperature. The simulations contained 4000 water molecules and the corresponding number of ions. In 0.5 M Fe Cl₂, most water molecules do not interact with ions. While the ion can form small clusters, they are homogeneously distributed throughout the system. In 0.5 M Fe Cl₂ + 4.5 M Mg Cl₂, the electrolyte structure and distribution of water change significantly. Ions form a continuous phase, and the water structure is significantly perturbed. The cation-oxygen of water (O_{w}) radial distribution functions (RDFs) with corresponding apparent coordination numbers (in bold lines) are shown in FIG. 41 as a function of shell radius, and the cation-anion RDFs and coordination numbers (in bold lines) are shown in FIG. 42. The strong first peak in the RDF defines the first solvation shell (3.40 Angstroms for Fe²⁺ and 3.15 Angstroms for Mg²⁺). The shorter Mg-O_{w} distances and stronger first and second solvation shell peaks of Mg²⁺ indicate that water molecules are tightly bound to Mg²⁺ due to stronger charge localization. The shorter Mg-Cl distance than Fe-Cl distance reveals a closer packing between Mg²⁺ and Cl⁻ than for the Fe²⁺. The number of water molecules and Cl⁻ in the salvation shell of Fe²⁺ and Mg²⁺ are given in Table 3.

TABLE 3

The coordination number of Ow and Cl in the salvation shell of Fe and Mg ions.

| System | Fe-O_{w}^{1st} | Fe-O_{w}^{2nd} | Fe-Cl | Mg-O_{w}^{1st} | Mg-O_{w}^{2nd} | Mg-Cl |
|---|---|---|---|---|---|---|
| 0.5 M FeCl₂ | 4.52 | 18.98 | 1.57 | NA | NA | NA |
| FERMI-4.5 | 3.01 | 16.17 | 3.12 | 3.40 | 11.62 | 2.36 |

The first salvation shell of Fe²⁺ contains an average of 4.5 water molecules and 1.6 Cl⁻ in 0.5 M FeCl₂. After adding 4.5 M MgCl₂, the solvation shell of Fe²⁺ changes to 3.0 water molecules and 3.1 Cl⁻. The first solvation shell of Mg²⁺ contains an average of 3.4 water molecules and 2.4 Cl⁻.

Analysis of water-water hydrogen bonding shows that in 0.5 M FeCl₂, water molecules on average have 3.2 H-bonds, with 36.6% of them participating in four or more H-bonds ( donor and acceptor combined), 32.1 % participating in three H-bonds, 23.1 % participating in two H-bonds and only a small fraction participating in one or no H-bond. Adding 4.5 M MgCl₂ significantly perturbs the H-bonding network between water molecules, as the average number of H-bonds per water molecule reduces to 2.2 and the fraction of water molecules that participate in four or more hydrogen bonds drops to 20.0%. Instead, the fraction of water molecules participating only in one or no H-bond increases to more than 32%. Note, in molecular simulations, depending on the geometric definition of the H-bond, molecules that have more than four H-bonds are possible, since no matter what definition one chooses, there will always be some molecules in transition between two H-bonds where both bonds will formally fall within the boundary of the definition and be counted. For the same reason, the computed average number of H-bonds per water molecule will be higher than in experiments. In addition to the reduced number of H-bonds per water, the averaged H-bond length increases from 2.024 Angstroms to 2.085 Angstroms after adding MgCl₂, indicating the weakening of H-bond strength.

In summary, the simulations show that electrolyte structure undergoes several major changes after adding 4.5 M MgCl₂: 1) Mg²⁺ strongly bound with water molecules; 2) the number of H-bonds per water molecule reduces from 3.2 to 2.2; 3) the number of water molecules in the first solvation shell of Fe²⁺ reduces from 4.5 to 3.0; and 4) the average length of H-bond increases. These changes are consistent with analyses based on the Raman spectroscopy and FT-IR results. With fewer H-bonds per water molecule and longer H-bonds, the water O—H covalent bond becomes shorter and stiffer, therefore making hydrogen evolution more difficult. In addition, the reduced number of water molecules in the hydration shell of Fe²⁺ makes water reduction more difficult because the likelihood of water reduction decreases when Fe²⁺ is brought to the vicinity of the electrode surface for the deposition reaction.

TABLE 4

The number of H-bonds per water molecule and the corresponding probability.

| | | | | | |
|---|---|---|---|---|---|
| System\Number of H-bonds | 4 and 4+ | 3 | 2 | 1 | 0 |
| 0.5 M FeCl₂ | 0.366 | 0.321 | 0.231 | 0.075 | 0.0 |
| 0.5 M FeCl₂ + 4.5 M MgCl₂ | 0.200 | 0.234 | 0.240 | 0.243 | 0.083 |

To further elucidate water molecule’s enhanced resistance to the reduction in FERMI-4.5, density functional theory (DFT) calculations were performed to calculate the reduction potentials of water in the solvation shell of different cations and water with different numbers of H-bonds. This investigation first addressed the reduction of MCl₂ clusters (M = Fe²⁺, Mg²⁺, and Ca²⁺) hydrated with five water molecules and one hydronium ion. The latter is introduced due to the acidic environment of the investigated electrolytes. Considering the first-electron reduction reaction generating the hydrogen radical as the rate-limiting step, the calculation of absolute reduction potential has been achieved by using a traditional Born-Harber cycle, which is widely used in the calculations of redox reactions for battery electrolytes and electrochemical reactions in aqueous phases. When Fe²⁺ is the cation, the reduction potential is -0.302 V vs. Fe/Fe²⁺, but the reduction potential reduces to -0.999 V and -0.723 V when the central cation is replaced with Mg²⁺ or Ca²⁺, respectively. Next, the investigation turned to the influence of the number of H-bonds per water molecule on its reduction. The experimental results above and MD simulation both show the average number of H-bonds per water decreases after adding 4.5 M MgCl₂. To examine how the number of explicit H-bonds that water molecules participate in affects its reduction potential, the reduction of water molecules with four H-bonds can be compared to molecules with two H-bonds. A water molecule with four H-bonds (2A2D) is represented by the central H₂O in a 5—H₂O cluster. Water with two H-bonds is represented by the central H₂O in a 3—H₂O cluster. Since there are three different isomers of 3-H₂O clusters with 1A1D, 0A2D, 2A0D H-bonds, the reduction potentials of central water in them were computed respectively to investigate how the H-bond type influences the reduction potential. Using the reduction potential of the central H₂O in a 5-H₂O cluster as the reference, the reduction potentials of central H₂O in the 3-H₂O clusters were found to be -0.565 V, -0.654 V, and -0.544 V for 2A0D, 1A1D, and 0A2D, respectively. The conducted DFT calculations demonstrate that 1) the presence of Mg²⁺ and Ca²⁺ makes water more reduction resistant, and 2) decreasing the number of H-bonds that water participates in also makes water molecules more reduction resistant.

Based on the above experimental results, the enhanced CE in FERMI and FERCI can be attributed to two reasons. First, less dead Fe during the stripping process. The presence of Mg²⁺/Ca²⁺ leads to Fe deposition with larger particle size and smaller surface area, which tends to form less “dead Fe” during stripping. Second, the suppression of HER because water molecules become more reduction resistant. The combined experimental and computational study suggests the enhanced water stability toward reduction is because: 1) water molecules are tightly bounded by Mg²⁺/Ca²⁺in their hydration shells; 2) Mg²⁺/Ca²⁺ significantly disrupts the H-bond network of water by reducing the H-bond per water and increasing H-bond length, therefore strengthening the covalent O—H bond of the water molecules, and 3) the reduced water concentration results in fewer water molecules in the hydration shell of Fe²⁺, which lowers the chance of water reduction when Fe²⁺ is brought to the electrode for Fe deposition.

In addition to the remarkable enhancement of CE for Fe deposition/stripping, this study can also be applied to a variety of aqueous electrolytes for electrochemical technologies. Increasing the concentration of FeCl₂ alone from 0.5 M to 3.0 M can increase CE from 0% to 79.4% (at pH =1). By adding more Fe salts to the Fe-electrolyte into the water-in-salt regime could further stabilize water and enhance the CE, as demonstrated in Zn electrolytes and Li electrolyte. However, the limited solubility of common Fe salts (FeCl₂: 3.57 M, FeSO₄: 3.0 M) makes it impossible to explore this regime of Fe electrolytes. It may be possible to reach higher iron ion concentrations with highly water-soluble salts based on organic anions such as bis(trifluoromethanesulfonyl)imide (TFSI⁻). The presence of a high concentration of Cl⁻ can enhance Fe deposition/stripping CE in electrolytes with NH₄⁺, but this appears only as a surface effect. This is because Cl⁻ can preferentially adsorb on the Fe electrode but imposes relatively smaller perturbation on the water structure. Such surface effects of Cl⁻ are dwarfed by the bulk electrolyte structure change when cations like Na⁺, Mg²⁺ and Ca²⁺ are added due to their strong ability to bound water. Because Na⁺ can also reduce the number of water molecules in the hydration shell of Fe²⁺ and disrupt water structure, adding Na⁺ to FE also enhances CE, albeit to a less extent compared to Mg²⁺ and Ca²⁺. Such supremacy of Mg²⁺ and Ca²⁺ over the monovalent Na⁺ is linked to their stronger ability of bounding water and their ability to perturb unoccupied molecular orbitals of hydration water. Between Mg²⁺ and Ca²⁺, Ca²⁺ is slightly less effective than Mg²⁺ in enhancing CE, which can be explained by its slightly weaker hydration than Mg²⁺ and its less extent of perturbing hydration water orbital. The effect of Mg²⁺ and Ca²⁺ in suppressing HER seems universal, as experimental results show that they can also enhance Zn deposition/stripping efficiency. Lastly, when the proposed electrolytes are used in a Fe metal battery with an intercalation cathode, such as the Prussian blue analog, Mg²⁺ or Ca²⁺ can also insert into the cathode. The selectivity of intercalation reaction toward the alkaline earth metal ion and Fe²⁺ can be considered. However, this is not a concern for Fe metal flow batteries, in which charge/discharge involves electron transfer from/to the soluble redox-active ions or molecules.

To further increase the efficiency, many possible strategies can be adopted. One can introduce some surface film forming components (additives, co-salts, co-solvents) into the aqueous electrolyte. This method is widely used in aqueous Li-ion batteries and Zn-ion batteries. The irreversible decomposition of these components may form an Fe²⁺ conductive but electron insulation film (termed as solid-electrolyte interphase, SEI), which allows the deposition of iron but prevents further decomposition of water, therefore improving the efficiency. Another strategy is to suppress HER by reducing water concentration, which can be done by further increasing the salt concentration or adding an organic solvent. HER can also be suppressed by increasing HER overpotential, which can be achieved by introducing anti-catalysts such as Bi onto the iron metal electrode. In addition, the morphology of the iron deposits can be further improved by adding surface surfactants to reduce the amount of dead iron.

In conclusion, the electrolytes described herein can support highly reversible Fe metal anode. The electrolytes show remarkably better Fe deposition/stripping efficiency (99.1%), higher conductivity, and lower overpotential than the baseline Fe electrolytes. Both half-cell and full-cell studies show batteries with the baseline Fe-electrolyte fail very quickly because the HER leads to large internal resistance, whereas batteries with the FERMI and FERCI electrolytes show significantly better cycling stability, which demonstrates the potential of these electrolytes for realizing long-cycle Fe metal batteries. Comprehensive experimental and computational studies reveal the enhanced Fe deposition/stripping efficiency is due to a synergy of improved deposit morphology (therefore less dead Fe) and enhanced water reduction resistance. Due to the simple fabrication method and low cost of raw materials, these novel electrolytes are ideal for unleashing the low-cost benefit of Fe metal batteries, especially Fe flow batteries. Broadly, the novel electrolytes reported here not only enable long-cycle Fe metal batteries but also open a new avenue to address the HER side reaction for other electrochemical technologies based on aqueous electrolytes, such as the CO₂ reduction, NH₃ synthesis, etc.

The extensive MD simulations were conducted using Atomistic Polarizable Potentials for Liquids, Electrolyte, and Polymers (APPLE&P) force field and WMI-MD simulation package. A 17.0 Angstroms cut-off distance with a tapering starting from 16.5 Angstroms was applied for the calculation of VDW interactions, short-range electrostatic interactions, and the real part of Ewald. All simulations were conducted at room temperature (298 K) and 1 atm pressure controlled by Nose-Hoover thermostat and barostat. A multi-step integration scheme has been used, in which the unit time step for the calculation of chemical bonds, bends was set to be 0.5 fs, while the 3 and 6 times of unit time were used for the shortrange non-bonded interactions and the remaining non-bonded interactions. A 3-fs time step is used for the Ewald summation in reciprocal space. The initial configuration of a simulation box was created by generating all the molecules in a large box (500 Angstroms). Within 30 ps, the box size was shrunk to the dimension corresponding to 1 g/cm³ density. The subsequent equilibration and productive runs were performed in the NPT ensemble. The calculations were conducted using B3L YP DFT potential, coupling with triple zeta basis set. The implicit polarizable continuum model (PCM) of water was used to mimic the influence of the coordination environment. Nevertheless, despite the endeavors in the development of implicit PCM models, explicit water molecules can dramatically enhance the accuracy of computation involving the H-bonds. All DFT calculations were conducted using the Gaussianl6 package.

### Definition of Potential Energy (Interaction Potentials)

$${U}^{t o t} \left(r\right) = {U}^{N B} \left(r\right) + {\sum }_{b e n d s} {U}^{B E N D S} \left({θ}_{i j k}\right) \qquad \text{(S1)}$$

In the simulations, all chemical bonds are constrained with the SHAKE algorithm at the tolerance of 10⁻¹⁴. Considering there are no definitions of torsional dihedral involving four atoms, only the spring-like bend potential as bond-based interactions defined by three atoms are introduced. In Eq S1, U^{tot} stands for total potential energy, U^{NB} for non-bonded potential energy. The equation for U^{NB} is given in Eq S2.

$$\begin{matrix}{U}^{N B} \left(r\right) = {U}^{R D} \left(r\right) + {U}^{c o u l} \left(r\right) + {U}^{p o l} \left(r\right) = \\ {\sum }_{i > j} \left({A}_{α β} exp \left(- {B}_{α β} {r}_{i j}\right) - {C}_{α β} {r}_{i j}^{6} + D {\left(\frac{12}{{B}_{α β} {r}_{i j}}\right)}^{12}\right) + \\ {\sum }_{i > j} \left(\frac{{q}_{i} {q}_{j}}{4 π {ε}_{0} {r}_{i j}}\right) - 0.5 {\sum }_{i} \vec{{μ}_{l}} \vec{{E}_{l}^{0}}\end{matrix} \qquad \text{(S2)}$$

Where A_{αβ}, B_{αβ}, and C_{αβ} describe the pairwise VDW interactions, D=5*10⁻⁵ Kcal/mol and the

$$D {\left(\frac{12}{{B}_{α β} {r}_{i j}}\right)}^{12}$$

term will build the repulsive wall for two species at close distance, qᵢ and qⱼ are the atomic charges for atoms i and j, εₐ denotes permittivity in a vacuum. The term

$$\vec{{E}_{l}^{0}}$$

is the electric field induced by atomic charges in the system while the

$$\vec{{μ}_{l}}$$

is an induced dipole at the force center. The combined rules shown in Eq S3 are used for heteroatom interactions:

$${A}_{i j} = \sqrt{{A}_{i i} {A}_{j j}} ∗ \frac{{B}_{i j}^{6}}{{B}_{i i}^{3} {B}_{j j}^{3}} ; {B}_{i j} = {\left(\frac{2}{{B}_{i i}^{- 6} + {B}_{j j}^{- 6}}\right)}^{\frac{1}{6}} ; {C}_{i j} = \sqrt{{C}_{i i} {C}_{j j}} \qquad \text{(S3)}$$

The studies used -4.42 V as the absolute value of SHE. The Fe/Fe²⁺ potential relative to SHE is -0.41 V. Therefore, the relationship between the absolute value of electrochemical potential E^{abs} and E vs Fe/Fe²⁺ can be established as E(vs Fe/Fe²⁺)= E^{abs}-4.42+0.41 = E^{abs}-4.01.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. An iron redox battery, comprising:
an aqueous electrolyte comprising a dissolved iron salt and a dissolved co-salt, wherein the co-salt comprises an anion and a cation, wherein the anion is at least one of a multiatomic anion, a bromide anion and an iodide anion, and wherein the cation is a magnesium ion, a calcium ion, or a combination thereof; and
an iron-reducing electrode in contact with the aqueous electrolyte.

2. The battery of claim 1, wherein the iron salt comprises iron(II) chloride (FeCl₂), iron(II) sulfate (FeSO₄), iron(II) bis(trifluoromethanesulfonyl)imide (FeTFSI₂), iron(II) trifluoromethanesulfonate (Fe(CF₃SO₃)₂), iron perchloride (Fe(ClO₄)₂), or a combination thereof.

3. The battery of claim 1, wherein iron ions from the iron salt are present in the electrolyte at a concentration from about 0.1 M to about 3.0 M.

4. The battery of claim 1, wherein the cation is magnesium.

5. The battery of claim 1, wherein the cation is calcium.

6. The battery of claim 1, wherein the cation is present in the electrolyte at a concentration from about 0.5 M to about 5.0 M.

7. The battery of claim 1, wherein the cation is present in the electrolyte at a concentration greater than 1.0 M and up to about 5.0 M.

8. The battery of claim 1, wherein the multiatomic anion comprises sulfate, perchlorate, nitrate, bis(trifluoromethanesulfonimide), trifluoromethanesulfonate, or a combination thereof.

9. The battery of claim 1, wherein the multiatomic anion comprises a multi-dentate anion.

10. The battery of claim 1, wherein the anion is one of bromide and iodide.

11. The battery of claim 1, wherein the aqueous electrolyte has a pH from about 1 to about 3.

12. The battery of claim 1, wherein the aqueous electrolyte has a viscosity of less than about 6.4 cP.

13. The battery of claim 1, wherein the battery operates substantially without evolving hydrogen gas from the aqueous electrolyte.

14. The battery of claim 1, wherein the battery is an iron redox flow battery and wherein the battery further comprises a pump configured to pump the aqueous electrolyte to the iron-reducing electrode.

15. The battery of claim 1, wherein the iron-reducing electrode comprises one or more of copper metal, iron metal, LiFePO₄, graphite, carbon felt, carbon cloth, carbon paper, and titanium.

16. The battery of claim 1, further comprising an iron oxidizing electrode comprising one or more of iron metal, graphite, carbon felt, carbon cloth, carbon paper, and titanium.

17. The battery of claim 1, wherein the battery is a LiFePO₄|Fe full cell, a CulFe two-electrode cell, a Cu|Fe|Fe three-electrode cell, a Fe|Fe symmetrical cell, a Fe³⁺/Fe cell, a Cl₂/Fe cell, a Br₂/Fe cell, a I/Fe cell, a O₂/Fe cell, or a Fe(CN)₆³⁻/Fe cell.

18. An aqueous redox flow battery, comprising:
an aqueous electrolyte comprising a dissolved salt of an active metal and a dissolved co-salt, wherein the active metal comprises chromium, titanium, manganese, nickel, zinc, tin, copper, or a combination thereof, and wherein the co-salt comprises an anion and a cation, wherein the anion is one or more of a multiatomic anion, bromide and iodide, and the cation is a magnesium ion, a calcium ion, or a combination thereof; and
an electrode in contact with the aqueous electrolyte.

19. A method of operating an iron redox battery, comprising:
depositing iron metal from an aqueous electrolyte within a battery onto an iron-reducing electrode while electric current flows through the battery in a first direction, wherein the aqueous electrolyte comprises dissolved iron salt and a dissolved co-salt, wherein the co-salt comprises an anion and a cation, wherein the anion is one or more of a multiatomic anion, bromide and iodide, and the cation is a magnesium ion, a calcium ion, or a combination thereof; and
stripping the iron metal from the iron-reducing electrode while electric current flows through the battery in a second direction, wherein the stripped iron metal is converted into iron ions dissolved in the aqueous electrolyte.

20. The method of claim 19, wherein the battery operates with a coulombic efficiency from about 95% to about 99.9%.

21. The method of claim 19, wherein substantially no hydrogen gas is evolved from the aqueous electrolyte.

22. The method of claim 19, wherein iron ions from the iron salt are present in the electrolyte at a concentration from about 0.1 M to about 3.0 M and wherein the cation is present in the electrolyte at a concentration from about 0.5 M to about 5.0 M.

23. The method of claim 19, wherein the battery is an iron redox flow battery and wherein the method further comprises pumping the aqueous electrolyte to the iron-reducing electrode.
